(19) United States
(12) Patent Application Publication
(10) Pub. No.: US 2025/0324339 A1
(43) Pub. Date: Oct. 16, 2025

(54) PSDB AND INTER-FLOW SYNCHRONIZATION HANDLING AT HANDOVER

(71) Applicant: QUALCOMM Incorporated, San Diego, CA (US)

(72) Inventors: Mickael MONDET, Louannec (FR); Veera Prasada Reddy KADIRI, San Diego, CA (US); Hyun Yong LEE, San Diego, CA (US); Diana MAAMARI, San Diego, CA (US); Prashanth Haridas HANDE, San Diego, CA (US); Peerapol TINNAKORNSRISUPHAP, San Diego, CA (US)

(21) Appl. No.: 18/636,102

(22) Filed: Apr. 15, 2024

(51) Int. Cl. H04W 36/24; H04W 36/32; H04W 56/00

(52) U.S. Cl. CPC H04W 36/249; H04W 36/324; H04W 56/0015

(57) ABSTRACT

A method for wireless communication at a source entity and related apparatus are provided. In the method, the source network entity communicates with a user equipment (UE) a first portion of a first protocol data unit (PDU) set, and provides, to a target network entity, transmission timing information corresponding to a remaining portion of the first PDU set. The transmission timing information is based on a switch time for a handover to the target network entity.

### TECHNICAL FIELD

The present disclosure relates generally to communication systems and, more particularly, to the handling of the protocol data unit (PDU) set delay budget (PSDB) and inter-flow synchronization at handover in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a source network entity. The apparatus may include at least one memory and at least one processor coupled to the at least one memory. Based at least in part on information stored in the at least one memory, the at least one processor, individually or in any combination, may be configured to communicate, with a user equipment (UE), a first portion of a first protocol data unit (PDU) set; and provide, for a target network entity, transmission timing information corresponding to a remaining portion of the first PDU set. The transmission timing information may be based on a switch time for a handover to the target network entity.

In an aspect of the disclosure, a method, a computer-readable medium, and an apparatus are provided for wireless communication at a target network entity. The apparatus may include at least one memory and at least one processor coupled to the at least one memory. Based at least in part on information stored in the at least one memory, the at least one processor, individually or in any combination, may be configured to receive, from a source network entity, an indication of transmission timing information related to a transmission of a first PDU set with a UE, where the transmission timing information is based on a switch time for a handover from the source network entity; and communicate, based on the transmission timing information, at least a portion of the first PDU set with the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A illustrates an example of extended reality (XR) traffic flows.

FIG. 4B illustrates an example of a UE exchanging XR traffic with an XR service or cloud gaming service, in accordance with various aspects of the present disclosure.

FIG. 5 is a diagram illustrating an example protocol data unit (PDU) set transmission in XR wireless communication.

FIG. 6 is a diagram illustrating an example PDU set delay budget (PSDB) for downlink communication.

FIG. 7 is diagram illustrating an example of multi-modal flows.

FIG. 8A is a diagram illustrating an example PSDB at handover.

FIG. 8B is a diagram illustrating an example synchronization threshold at handover.

FIG. 9 is a diagram illustrating examples of the remaining time until the PSDB expires after a handover in accordance with various aspects of the present disclosure.

FIG. 10A is a diagram illustrating an example of the synchronization threshold expiration information after a handover for multi-modal flows in accordance with various aspects of the present disclosure.

FIG. 10B is a diagram illustrating an example of the synchronization threshold expiration information after a handover for multi-modal flows in accordance with various aspects of the present disclosure.

FIG. 11 is a diagram illustrating an example of a handover for multi-modal flows in accordance with various aspects of the present disclosure.

FIG. 12 is a diagram illustrating an example of the transfer of the transmission timing information in accordance with various aspects of the present disclosure.

FIG. 13 is a diagram illustrating an example of the transfer of the transmission timing information in accordance with various aspects of the present disclosure.

FIG. 14 is a call flow diagram illustrating a method of wireless communication in accordance with various aspects of the present disclosure.

FIG. 15 is a flowchart illustrating methods of wireless communication at a source network entity in accordance with various aspects of the present disclosure.

FIG. 16 is a flowchart illustrating methods of wireless communication at a source network entity in accordance with various aspects of the present disclosure.

FIG. 17 is a flowchart illustrating methods of wireless communication at a target network entity in accordance with various aspects of the present disclosure.

FIG. 18 is a flowchart illustrating methods of wireless communication at a target network entity in accordance with various aspects of the present disclosure.

FIG. 19 is a diagram illustrating an example of a hardware implementation for an example apparatus and/or UE.

FIG. 20 is a diagram illustrating an example of a hardware implementation for an example network entity.

### DETAILED DESCRIPTION

High-speed, low-latency, and high-reliability wireless communication enable latency-sensitive services, such as extended reality (XR) services or applications. These services or applications may have strict performance criteria for data rate, latency, and power consumption. For example, to ensure a seamless user experience in XR applications, 99% of XR data packets are to be delivered within a short packet delay budget (PDB), such as ten milliseconds (ms). Additionally, XR applications may involve receiving data from various multi-modal data flows on the user equipment (UE), and these multi-modal data flows may have specific synchronization thresholds for reception. However, as the UE operates within cellular networks, the UE may perform mobility procedures, such as handovers, to change the network entity to which the UE connects. Mobility procedures may complicate packet delivery for XR applications, and may pose a challenge to maintaining the desired quality of service for these applications. Example aspects presented herein provide methods and apparatus for handling the protocol data unit (PDU) set delay budget (PSDB) and inter-flow synchronization at mobility procedures, such as handovers.

Various aspects relate generally to wireless communication. Some aspects more specifically relate to handling protocol data unit (PDU) set delay budget (PSDB) and inter-flow synchronization at handover. In some examples, a source target entity may communicate, with a UE, a first portion of a first PDU set; and provide, for a target network entity, transmission timing information corresponding to a remaining portion of the first PDU set. The transmission timing information may be based on a switch time for a handover to the target network entity. In some examples, the transmission timing information for the first PDU set may include one or more of: PDU set delay budget (PSDB) expiration information for the first PDU set, or synchronization expiration information for the first PDU set and a second PDU set. The first PDU set may be associated with a first flow, the second PDU set may be associated with a second flow, and the first flow and the second flow may be associated with a multi-modal application. As an example, the PSDB expiration information may include a remaining time until the expiration of a PSDB for the first PDU set or an absolute time at the expiration of the PSDB for the first PDU set. As an example, the synchronization expiration information may include the remaining time until the expiration of a synchronization threshold between the first PDU set and the second PDU set or an absolute time at the expiration of the synchronization threshold.

Particular aspects of the subject matter described in this disclosure can be implemented to realize one or more of the following potential advantages. In some examples, by ensuring that PDU sets are transmitted within their PSDB and synchronization thresholds during mobility procedures, such as handovers, the described techniques maintain consistent service quality for latency-sensitive applications, such as XR applications. In some examples, by informing the target network entity of the PSDB expiration information and synchronization threshold expiration information for forwarded PDU sets, the described techniques enable more informed scheduling decisions, thereby improving resource utilization and reducing unnecessary delays.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

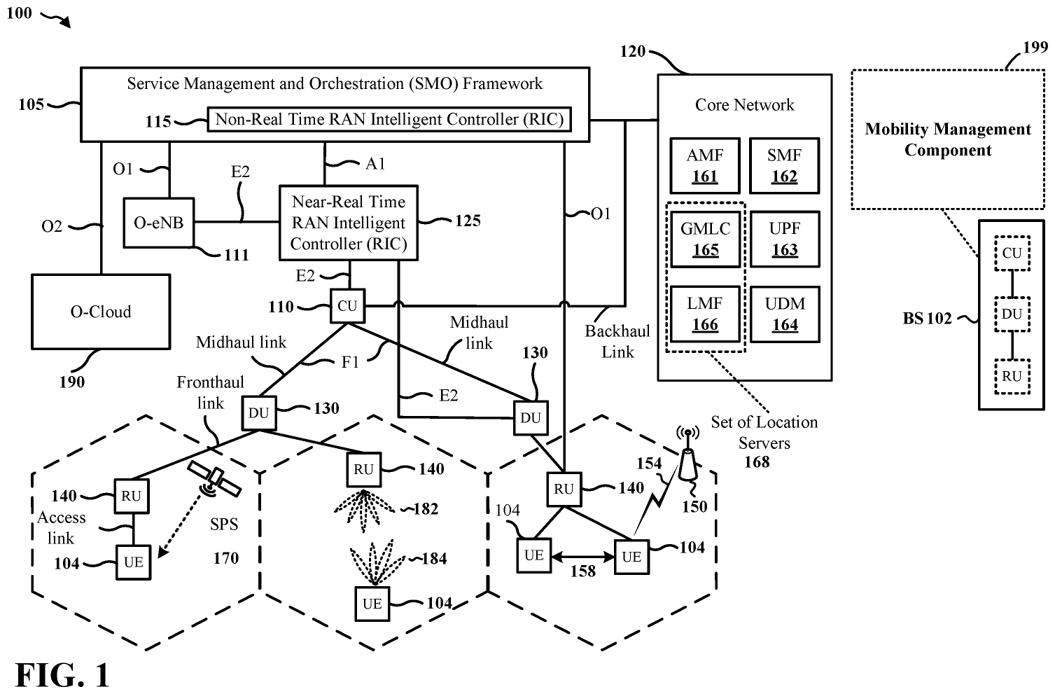

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 102 may include a mobility management component 199. In some examples, the mobility management component 199 may be configured to communicating, with a UE, a first portion of a first PDU set; and provide, to a target network entity, transmission timing information corresponding to a remaining portion of the first PDU set. The transmission timing information may be based on a switch time for a handover to the target network entity. In some examples, the mobility management component 199 may be configured to receive, from a source network entity, an indication of transmission timing information related to a transmission of a first PDU set with a UE, where the transmission timing information is based on a switch time for a handover from the source network entity; and communicate, based on the transmission timing information, at least a portion of the first PDU set with the UE. Although the following description may be focused on 5G NR, the concepts described herein may be applicable to other similar areas, such as LTE, LTE-A, CDMA, GSM, and other wireless technologies.

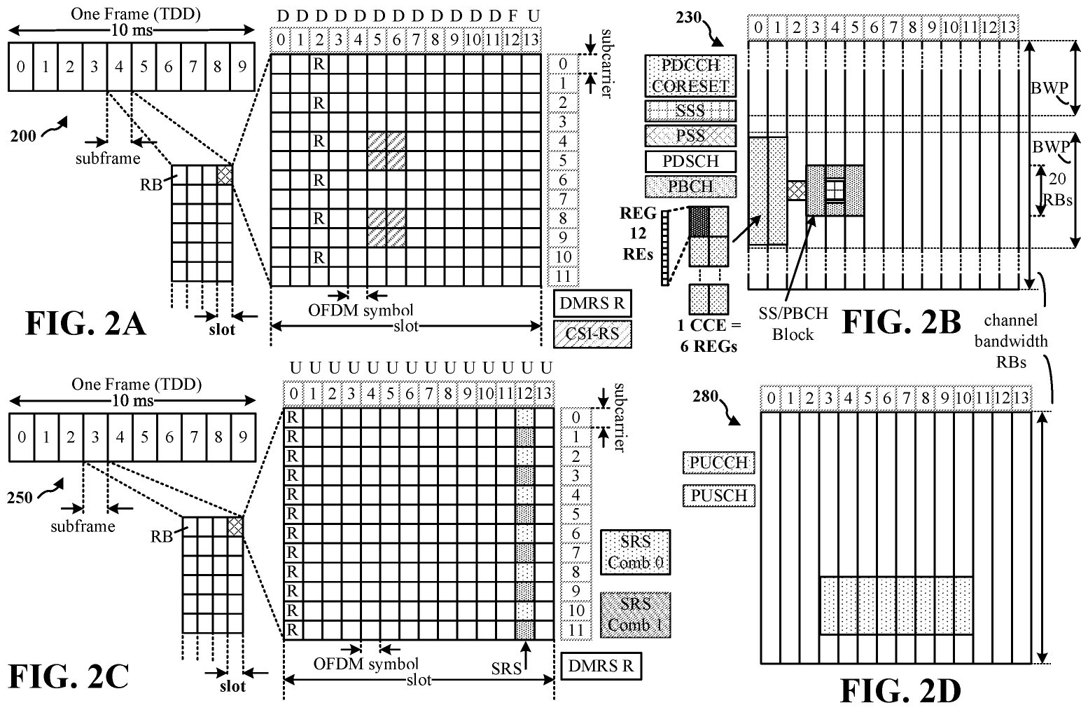

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

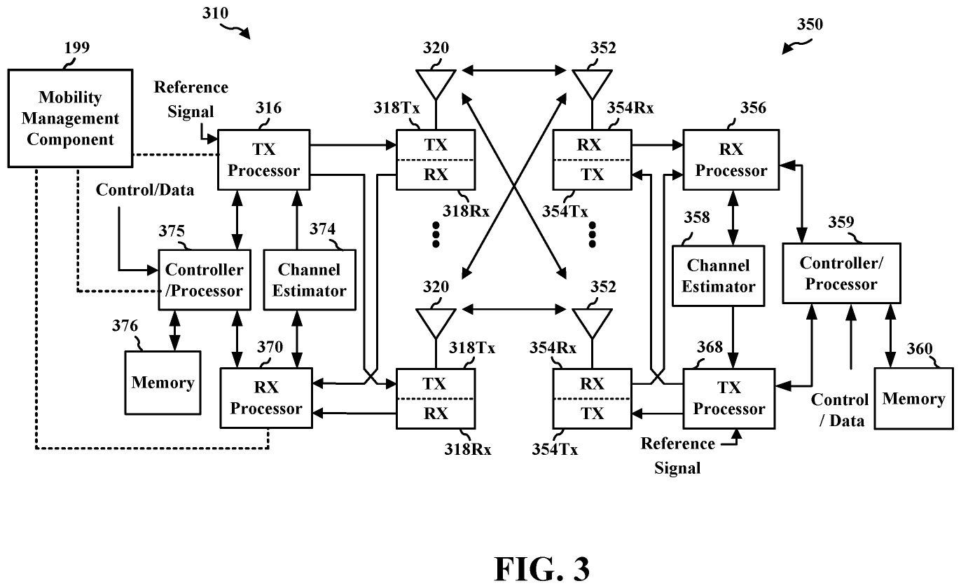

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the mobility management component 199 of FIG. 1.

Extended reality (XR) traffic may refer to wireless communications for technologies such as virtual reality (VR), mixed reality (MR), and augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In some examples, an AR system may overlay sensory information (e.g., images) onto a natural environment and/or mask real objects from the natural environment. XR traffic may include video data and/or audio data. XR traffic may be transmitted by a base station and received by a UE, or the XR traffic may be transmitted by a UE and received by a base station.

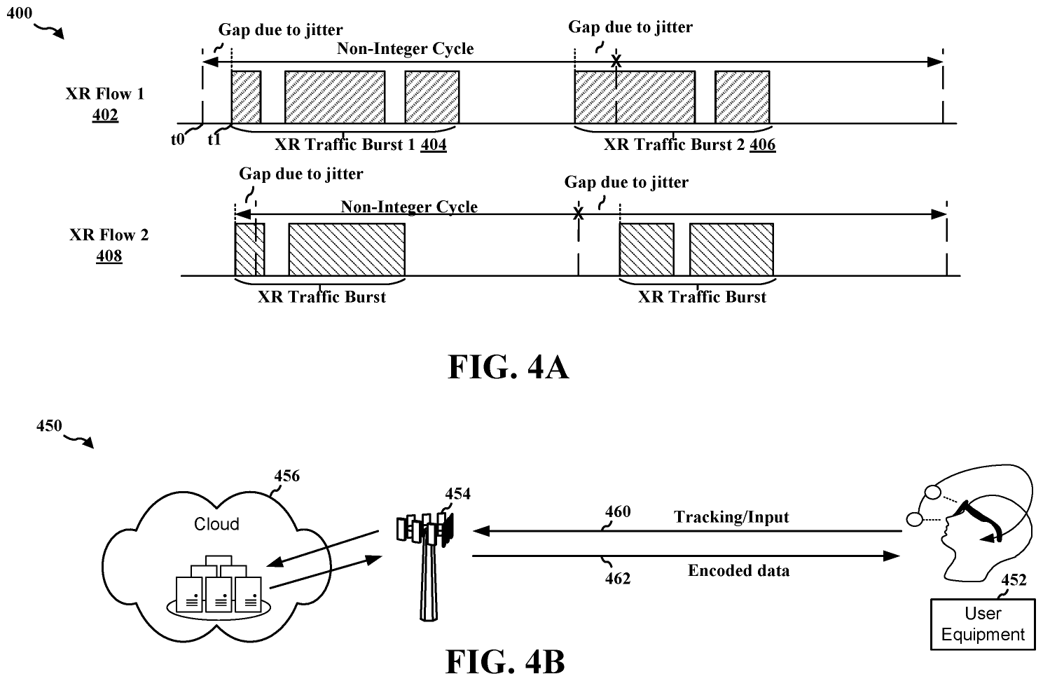

XR traffic may arrive in periodic traffic bursts (“XR traffic bursts” or “XR bursts”). An XR traffic burst may vary in a number of packets per burst and/or the size of each pack in the burst. The diagram 400 in FIG. 4A illustrates a first XR flow 402 that includes a first XR traffic burst 404 and a second XR traffic burst 406. As illustrated in the diagram 400, the traffic bursts may include different numbers of packets. For example, the first XR traffic burst 404 is shown with three packets (represented as rectangles in the diagram 400) and the second XR traffic burst 406 is shown with two packets. Furthermore, as illustrated in the diagram 400, the three packets in the first XR traffic burst 404 and the two packets in the second XR traffic burst 406 may vary in size. That is, packets within the first XR traffic burst 404 and the second XR traffic burst 406 may include varying amounts of data.

XR traffic bursts may arrive at non-integer periods (i.e., in a non-integer cycle). The periods may differ from an integer number of symbols, slots, etc. In one example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than the time at which a UE (or a base station) expects the XR traffic bursts. The variability of the packet arrival relative to the period (e.g., 16.76 ms period, 8.33 ms period, etc.) may be referred to as “jitter.” In one example, jitter for XR traffic may range from −4 ms (earlier than expected arrival) to +4 ms (later than expected arrival). For instance, referring to the first XR flow 402, a UE may expect a first packet of the first XR traffic burst 404 to arrive at time t0, but the first packet of the first XR traffic burst 404 arrives at time t1.

XR traffic may include multiple flows that arrive at a UE (or a base station) concurrently with one another (or within a threshold period of time). For instance, the diagram 400 includes a second XR flow 408. The second XR flow 408 may have different characteristics than the first XR flow 402. For instance, the second XR flow 408 may have XR traffic bursts with different numbers of packets, different sizes of packets, etc. In one example, the first XR flow 402 may include video data, and the second XR flow 408 may include audio data for the video data. In another example, the first XR flow 402 may include intra-coded picture frames (I-frames) that include complete images, and the second XR flow 408 may include predicted picture frames (P-frames) that include changes from a previous image.

FIG. 4B is a diagram 450 illustrating an example of wireless communication between a user equipment (UE) 452, a base station 454, and a cloud server 456. In some aspects, the service provided to the UE 452 may be an XR service or a cloud gaming service, and the associated traffic may be associated with a low latency. As an example, the uplink (UL) packet 460 may include input information such as tracking information or user pose information for the XR service or inputs for the cloud gaming service. In some examples, the UL packet 460 may include data of 100 bytes every 2 ms (at 500 Hz). The cloud server 456 may receive the UL packet 460 and generate the downlink (DL) packet 462 based on the received UL packet 460. For example, the cloud server 456 may receive the UL packet 460 including the tracking/pose information for the XR service or inputs for the cloud gaming service, and generate the DL packet 462 based on the received UL packet 460 including the tracking/pose information for the XR service or inputs for the cloud gaming service.

The DL packet 462 may include an encoded data associated with the service provided to the UE. For example, the encoded data may include data of over 100 kilobytes at 45, 60, 75, or 90 frames per second (fps), i.e., every 22, 16, 13, or 11 milliseconds. The XR service or the cloud gaming service may be provided from a cloud server, and the DL packet 462 may include a quasi-periodic encoded video with burst frame every

$$\frac{1}{fps}$$

seconds or two, possibly staggered, “eye-buffers” (or images) per frame every

$$\frac{1}{2 * fps}$$

SAULIUS. III an CAampic In winch the UE is provided with the cloud gaming service, the DL packet may include a quasi-periodic encoded video with burst frame every

$$\frac{1}{fps}$$

seconds. In an example in which the UE is provided with the XR service, the DL packet 462 may include a quasi-periodic encoded video with separate images, staggered or simultaneously, for each eye per frame every

$$\frac{1}{2 * fps}$$

seconds. In some aspects, the latency observed from the UE 452 may be associated with a round-trip time (RTT) between transmitting the UL packet 460 and receiving the DL packet 462. That is, the network latency experienced at the UE 452 may be determined based on a RTT between transmitting the UL packet 460 including the tracking/pose information for the XR service or the inputs for the cloud gaming service and receiving the DL packet including the encoded data associated with the service provided to the UE 452.

High-speed, low-latency, and high-reliability wireless communication enable latency-sensitive services, such as immersive XR multimedia applications, including AR glasses, VR HMD, cloud gaming, and cloud-based AI services. These applications may have strict performance criteria for data rate, latency, and power consumption. For example, to ensure a seamless user experience in XR applications, 99% of XR packets should be delivered within a short PDB, such as ten milliseconds (ms). However, as a UE operating in cellular networks, it may encounter mobility procedures that can significantly increase the packet delay for real-time multimedia traffic, posing a challenge for maintaining the desired quality of service for latency-sensitive applications.

Example aspects presented herein provide methods and apparatus for managing the PSDB and inter-flow synchronization at mobility procedures, such as handovers. In some examples, the methods of the present disclosure provide more detailed granularity within the flow PDU set during the handovers. Additionally, some examples demonstrate methods for achieving synchronization between two PDU sets operating in multi-modal operations.

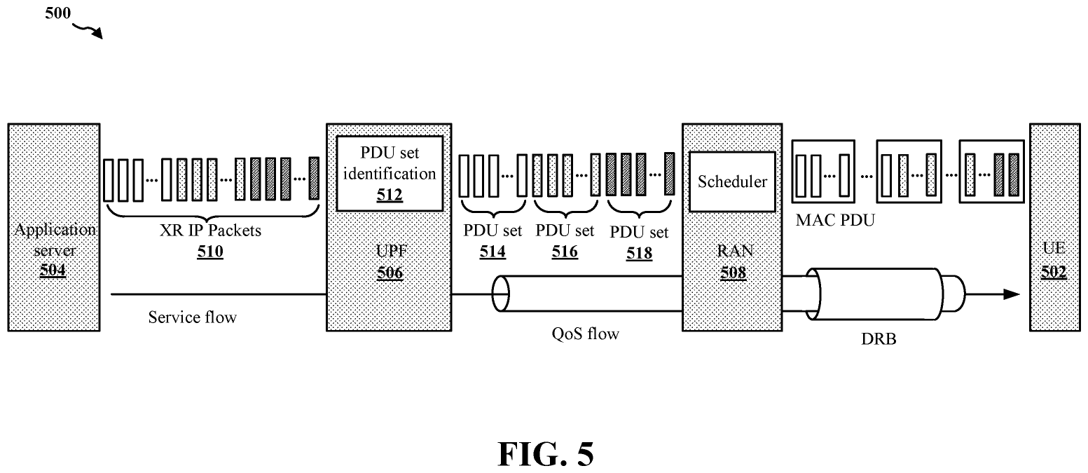

In wireless communication, a protocol data unit (PDU) may refer to a unit of data packets transmitted among peer entities of a communication network. PDUs may include layers of information that are added or removed as data packets traverse through various layers (e.g., physical layer, application layer) of communication protocols during the communication process. A PDU set may refer to a group of PDUs that are consumed by an application at approximately the same time. For example, in XR applications, a PDU set may include a group of PDUs associated with a video frame. FIG. 5 is a diagram 500 illustrating an example PDU set transmission in XR wireless communication. As shown in FIG. 5, in wireless communication, such as communication involving an XR application, a set of XR internet protocol (IP) packets 510 may be transmitted from the application server 504 to the user plane function (UPF) 504 (e.g., such as UPF 163 shown in FIG. 1). The UPF may include a PDU set identification 512. After the UPF 506, the XR IP packets 510 may be grouped into one or more PDU sets, such as PDU set 514, PDU set 516, and PDU set 518. These PDU sets are then routed through the radio access network (RAN) 508 for delivery to the UE 502.

The PDUs in a PDU set (e.g., PDU set 514, PDU set 516, and PDU set 518) should be delivered within a certain time limit to ensure a satisfactory user experience. The maximum allowed time span for a PDU set to be transmitted from one point to another within the network may be referred to as the PDU set delay budget or PSDB. For example, PSDB may define the upper bound for the amount of delay a PDU set may experience during their transfer between the UE (e.g., UE 502) and a termination point (e.g., the N6 termination point) at the UPF (e.g., UPF 506).

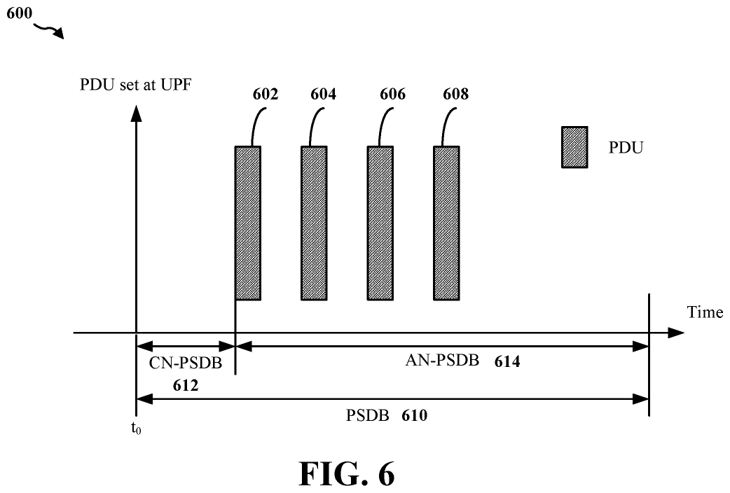

PSDB may apply to both downlink and uplink communication. FIG. 6 is a diagram 600 illustrating an example PSDB for downlink communication. For downlink transmissions, the PSDB 610 may be the maximum allowed time span between the time from when the first PDU (e.g., PDU 602) in the PDU set (which may include PDU 602, 604, 606, 608) is received at the UPF (e.g., at time to) and the time all PDUs (e.g., PDU 602, 604, 606, 608) in the PDU set have been successfully received by the UE. For uplink transmissions, the PSDB may be the maximum allowed time span between the reception of the first PDU in the PDU set at the UE and the time when all PDUs in the PDU set have been successfully received at the UPF. In some examples, PSDB may further include the delay budget for the core network, which may be referred to as core network PSDB or CN-PSDB (e.g., CN-PSDB 612), and the delay budget for the access network, which may be referred to as the access network PSDB or AN-PSDB (e.g., AN-PSDB 614). The CN-PSDB (e.g., CN-PSDB 612) may be the maximum time span allowed for the PDU set transmission within the core network, and the AN-PSDB (e.g., AN-PSDB 614) may be the maximum time span allowed for PDU set transmission between UE and the core network.

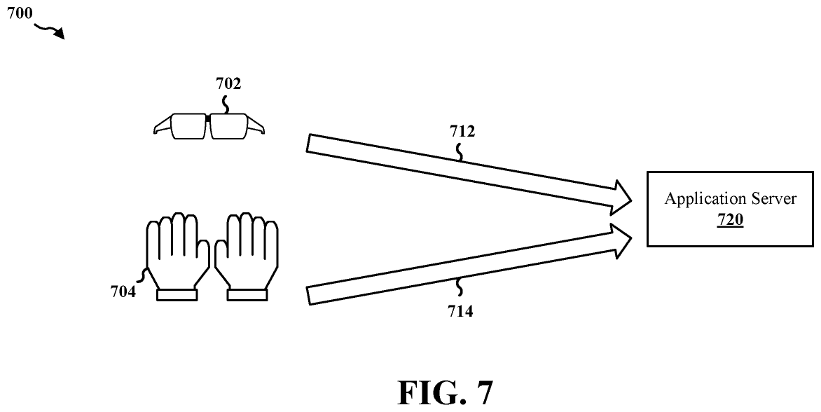

In some examples, the operations of an application (e.g., XR application) may involve the use of tactile and multi-modal communication services. Tactile and multi-modal communication services facilitate multi-modal interactions (e.g., interactions based on visual, auditory, and touch feedback, respectively), which ask for ultra-low latency, high availability, reliability, and security data transmissions. FIG. 7 is a diagram 700 illustrating an example of multi-modal flows. In FIG. 7, an application server 720 may receive multi-modal data flows respectively from multiple UEs. For example, the multi-modal data flows may include a first data low 712 from a first UE for visual feedback (e.g., VR glasses 702) and a second data flow 714 from a second UE for touch feedback (e.g., gloves 704). Multi-modal communication services may enable immersive multi-modal XR applications. For a good immersive experience, data from various multi-modal flows (e.g., the first data flow 712 and the second data flow 714) may be synchronized. For example, the data for the VR glasses 702 should match the data from the gloves 704 in the time domain. This means that data from the multi-modal flows should be received by a receiving entity (e.g., a UE or a network node, such as application server 720) within a synchronization threshold (e.g., 15, 25, or 50 ms).

In some examples, multi-modal applications may support scenarios where a single UE or multiple UEs are involved. For multi-modal applications that involve a single UE, all application data for the single UE, even when including multiple data flows, may be transmitted within a single PDU session. A multi-modal service identifier (ID) may be provided to associate various data flows with a multi-modal service. For multi-modal applications that involve multiple UE, the UE may share the same data network name (DNN)/single network slice selection assistance information (S-NSSAI) combination, indicating their participation in the multi-modal service. In some examples, the same multi-modal service ID may be assigned across all PDU sessions of the UEs engaged in the multi-modal service, and the policy control function (PCF) may use this information to establish policy and charging control (PCC) rules.

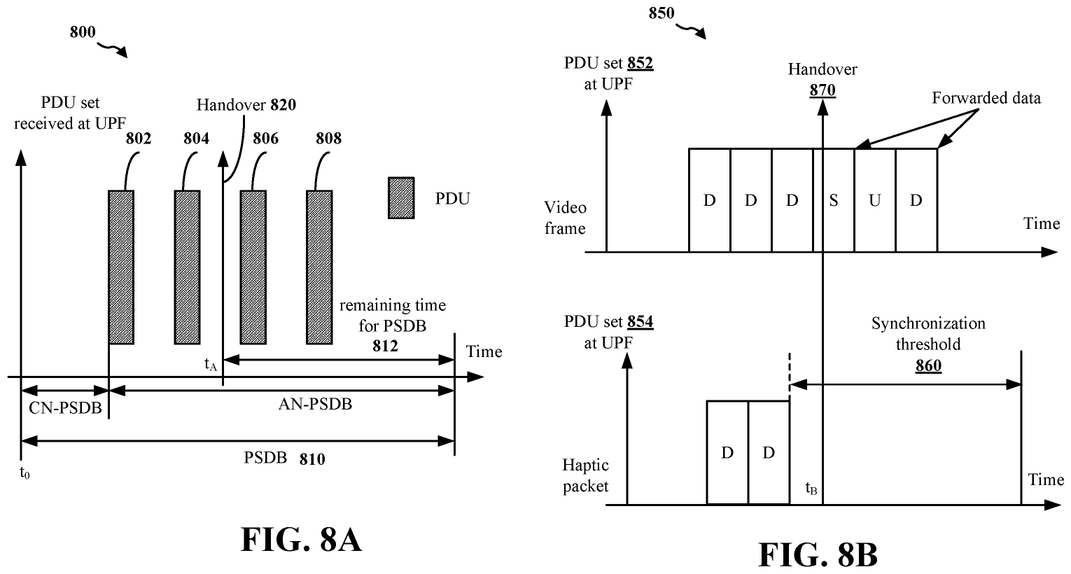

During the mobility procedures, such as handovers, the downlink PDU set received by the source cell may be forwarded to the target cell. However, the target cell may not have the transmission timing information of the forwarded PDU set. For example, the target may lack information on when the PSDB for the forwarded PDU set is due to expire or when the synchronization threshold for PDU sets that belong to the same multi-modal service will expire. The lack of this information may prevent the target cell from scheduling the transmissions of the forwarded PDU sets efficiently, which may negatively affect the user experience. FIG. 8A is a diagram 800 illustrating an example PSDB at handover. In FIG. 8A, the PDU set to be downlink transmitted to a UE may include four PDUs (e.g., PDU 802, 804, 806, and 808). The PDU set may have an associated PSDB 810, within which their transmission should be completed. The source cell may transmit two of these PDUs (e.g., PDU 802 and 804) before the handover 820 (e.g., at t_{A}) to the target cell. After the handover 820, the UE may continue to receive the remaining PDUs in the PDU set (e.g., PDU 806 and 808) from the target cell. Providing information on when the PSDB 810 for the PDU set is due to expire (e.g., the remaining time 812 for the PSDB 810) to the target cell may help the target cell to schedule the transmission for the remaining PDUs (PDU 806 and 808) efficiently. FIG. 8B is a diagram 850 illustrating an example synchronization threshold at handover. In FIG. 8B, the source cell may transmit two PDU sets associated with the multi-modal flows to a UE. As an example, the first PDU set 852 may be associated with a video frame, and the second PDU set 854 may be associated with a haptic packet. The difference between the receive times of these two PDU sets at the UE may not exceed the synchronization threshold 860. When there is a handover 870 (e.g., at t_{B}) to a target cell during the transmission of these two PDU sets, providing information on when the synchronization threshold 860 will expire may help the target cell to schedule the transmission of these two PDU sets more efficiently.

Example aspects presented herein provide methods and apparatus for managing the PSDB and inter-flow synchronization at mobility procedures. The mobility procedures may include, for example, an unconditional handover to the target cell, a conditional handover to the target cell, or a lower-layer triggered mobility (LTM) to the target cell, such as layer 1/layer 2 (L1/L2) triggered mobility to the target cell. In some aspects, to ensure efficient transmission of the forwarded PDU sets during the handover process, the target cell may be informed about the expiration information of the PSDB for each PDU set it receives. In one configuration, the source cell may provide information regarding the PSDB expiration information for any PDU set that is fully or partly forwarded to the target cell.

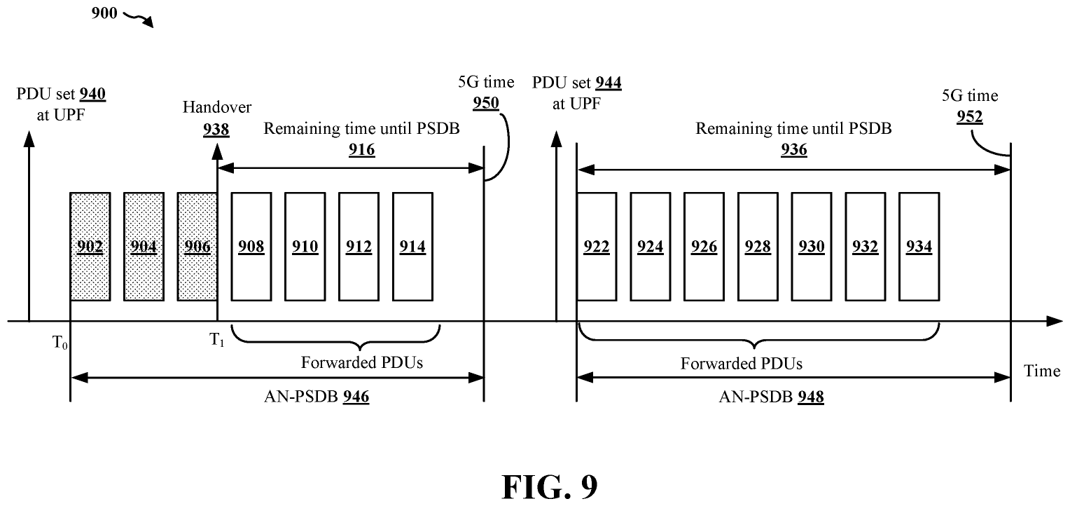

In some examples, the information regarding the PSDB expiration may include the remaining time until the PSDB expires. In some examples, the remaining time until the PSDB expires (denoted as RT_{PSDB}) may be based on the time of the handover, which may be referred to as the switch time, in some aspects, in relation to the forwarding process and the PSDB for the PDU set. FIG. 9 is a diagram 900 illustrating examples of the remaining time until the PSDB expires after a handover in accordance with various aspects of the present disclosure. In FIG. 9, the first PDU set 940 may include a set of PDUs 902, 904, 906, 908, 910, 912, and 914. The handover 938 to the target cell may happen at time T1. After the handover 938, the source cell may forward the PDU it receives after the handover 938 to the target cell. For example, the source cell may forward PDUs 908, 910, 912, and 914 to the target cell. These PDUs (e.g., PDUs 908, 910, 912, and 914) may be useful to the receiver (e.g., the target cell) until their discard timer expires. In FIG. 9, the first PDU set 940 may arrive at the source cell before the forwarding process begins (e.g., before the handover 938 at T₁). For the first PDU set 940, the remaining time 916 (e.g., RT_{PSDB}) may be calculated by:

$${RT}_{PSDB} = {AN}_{PSDB} - ( {T}_{1} - {T}_{0} ) \qquad ( 1 )$$

where AN_{PSDB} is the access network PSDB (e.g., AN-PSDB 946) for the first PDU set 940. To is the arrival time of the first PDU (e.g., PDU 902) in the PDU set 940, and T₁ is the time when the forwarding (e.g., handover 938) starts. FIG. 9 further illustrates the second PDU set 944, which may include PDUs 922, 924, 926, 928, 930, 932, and 934. The second PDU set 944 may reach the source cell after the forwarding process has started (e.g., after the handover 938 at T₁). For the second PDU set 944, the remaining time 936 (e.g., RT_{PSDB}) may equal AN_{PSDB} (e.g., AN-PSDB 948), which is the access network PSDB for the second PDU set 944.

In some examples, the information regarding the PSDB expiration may include an absolute time (e.g., the 5G time, in one non-limiting example) at which the PSDB is set to expire. As used herein, the term “5G time” may refer to the combination of the radio frame number and the slot number inside the radio frame. In some aspects, the absolute time (e.g., the 5G time) at the expiration of the PDU set may be the system time, which may be expressed as the radio frame number at the expiration of the PSDB and the slot number within the radio frame at the expiration of the PSDB. For example, referring to FIG. 9, for the first PDU set 940, the absolute time at which its PSDB is set to expire may be 5G time 950, which may be expressed as the radio frame number and the slot number in the radio frame number at the expiration of the PSDB (e.g., AN-PSDB 946). For the second PDU set 944, the absolute time at which its PSDB is set to expire may be 5G time 952, which may be expressed as the radio frame number and the slot number in the radio frame number at the expiration of the PSDB (e.g., AN-PSDB 948).

In some examples, the PSDB expiration information (e.g., the remaining time until the PSDB expires or the absolute time (e.g., the 5G time) when the PSDB expires) may be provided with the PDUs that are forwarded to the target cell. For example, referring to FIG. 9, the PDUs 908, 910, 912, and 914 in the first PDU set 940 may be forwarded to the target cell, and all the PDUs (e.g., PDU 922, 924, 926, 928, 930, 932, and 934) in the second PDU set 944 may be forwarded to the target cell. The PSDB expiration information for these PDU sets (e.g., the remaining time 916 or the 5G time 950 for the first PDU set 940, and the remaining time 936 or the 5G time 952 for the second PDU set 944) may be provided to the target cell along with the forwarded PDUs of the corresponding PDU sets.

In some examples, a special value may be designated for the PSDB expiration information to indicate cases where the PSDB has already expired.

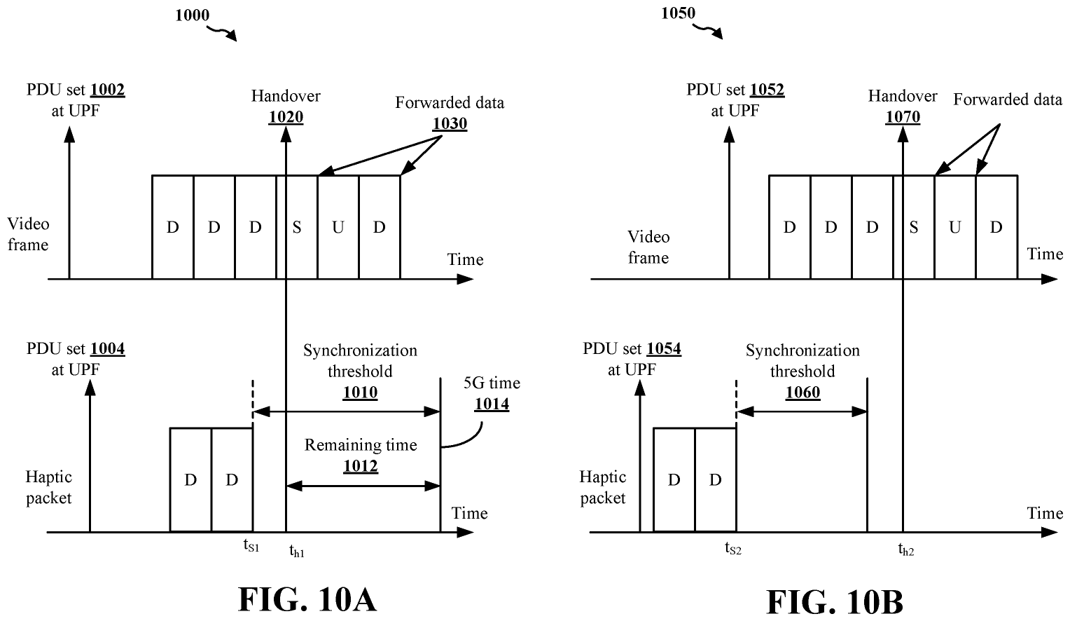

In some aspects, during handovers for multi-modal flows, the source cell may provide the synchronization threshold expiration information for the target cell. FIG. 10A is a diagram 1000 illustrating an example of the synchronization threshold expiration information after a handover for multi-modal flows in accordance with various aspects of the present disclosure. FIG. 10B is a diagram 1050 illustrating another example of the synchronization threshold expiration information after a handover for multi-modal flows in accordance with various aspects of the present disclosure. In the examples of FIG. 10A and FIG. 10B, the multi-modal flows may include two flows. As an example, one flow may correspond to a video frame, while the other flow may correspond to the haptic packet. The first PDU set (e.g., 1002 or 1052) may be associated with the video frame flow, and the second PDU set (e.g., 1004 or 1054) may be associated with the haptic packet flow. The synchronization timer for multi-modal flows may start when one PDU set (e.g., the second PDU set 1004, 1054) from one flow of the multi-modal flows has been successfully delivered (e.g., at tₛ₁ or tₛ₂), initiating the synchronization timer the other flows involved. If a handover (e.g., handover 1020, 1070) takes place after this PDU set (e.g., the second PDU set 1004, 1054) has been delivered but before the PDU set (e.g., the first PDU set 1002, 1052) of the other quality of service (QOS) flow has been delivered, two possible scenarios may be present. In one scenario, as shown in FIG. 10A, the synchronization threshold 1010 has not yet expired at the time of handover 1020. In another scenario, the synchronization threshold 1060 has expired at the time of handover 1070. With both of these scenarios, when receiving forwarded PDUs from the PDU set that has not been delivered (e.g., the first PDU set 1002, 1052), providing the time the synchronization threshold (e.g., 1010, 1060) is set to expire to the target cell may be beneficial for the target cell.

In some aspects, if the source cell has determined a synchronization threshold (e.g., synchronization threshold 1010, 1060) for PDU sets that need to be fully or partly forwarded (e.g., the first PDU set 1002, 1052) to the target cell at handover, the source cell may provide the synchronization threshold expiration information to the target cell at handover. This information may either be the remaining time until the synchronization threshold expires (e.g., the remaining time 1012) or the absolute time (e.g., 5G time 1014) when the synchronization threshold (e.g., synchronization threshold 1010) is set to expire.

In some examples, the remaining time until the synchronization threshold expires (e.g., denoted as RT_{ST}) may be determined based on the time of the handover (e.g., the time when data forwarding starts), such as tₕ₁ for handover 1020, and the time (e.g., tₛ₁ for PDU set 1004d) of the successful delivery of the PDU set that has been delivered (e.g., the second PDU set 1004). For example, the remaining time may be calculated by:

$${RT}_{ST} = {T}_{syn} - ( {T}_{1} - {T}_{0} ) \qquad ( 2 )$$

where T_{syn} is the synchronization threshold (e.g., synchronization threshold 1010), To is the time of the successful delivery of the delivered PDU set (e.g., tₛ₁ for PDU set 1004), and T₁ is the time of the handover (e.g., the time when the data forwarding starts), such as tₕ₁ for handover 1020.

In some examples, the absolute time (e.g., the 5G time 1014) when the synchronization threshold (e.g., synchronization threshold 1010, 1060) is set to expire may be the system time, which may be expressed as the radio frame number at the expiration of the synchronization threshold (e.g., synchronization threshold 1010) and the slot number within the radio frame at the expiration of the synchronization threshold (e.g., synchronization threshold 1010).

In some examples, the synchronization threshold expiration information may be provided with the PDUs that are forwarded to the target cell. For example, referring to FIG. 10A, the synchronization threshold expiration information for synchronization threshold 1010 (e.g., the remaining time 1012 or the absolute time, such as 5G time 1014, for synchronization threshold 1010) may be provided to the target cell with the forwarded data 1030.

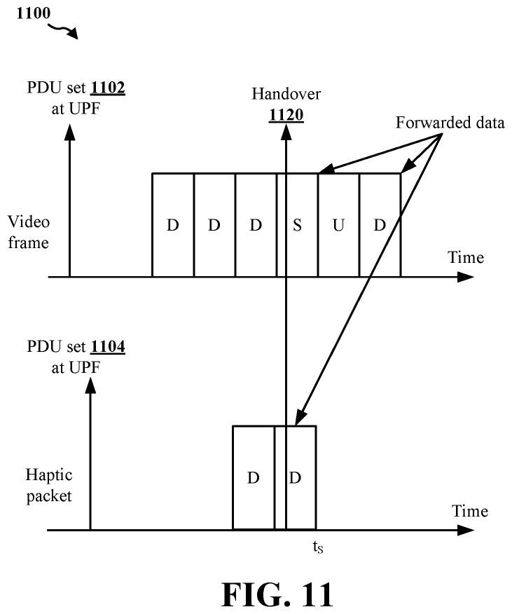

In some examples, no PDU set may have been successfully delivered to the UE when the handover is taking place. In this case, the target cell may be responsible for determining the applicable synchronization threshold. FIG. 11 is a diagram 1100 illustrating an example of a handover for multi-modal flows in accordance with various aspects of the present disclosure. In FIG. 11, the multi-modal flows may include two flows. As an example, one flow may correspond to a video frame, while the other flow may correspond to the haptic packet. The first PDU set 1102 may be associated with the video frame flow, and the second PDU set 1104 may be associated with the haptic packet flow. In the example of FIG. 11, no PDU set may have been successfully delivered to the UE when the handover 1120 is taking place. Hence, the target cell may determine the applicable synchronization threshold.

In some examples, a special value may be designated for the synchronization threshold expiration information to indicate cases where the synchronization threshold has already expired. For example, referring to FIG. 10B, when the synchronization threshold 1060 has already expired at the time the handover 1070 happens, the synchronization threshold expiration information that was provided to the target cell may include a special value to indicate that the synchronization threshold 1060 has already expired.

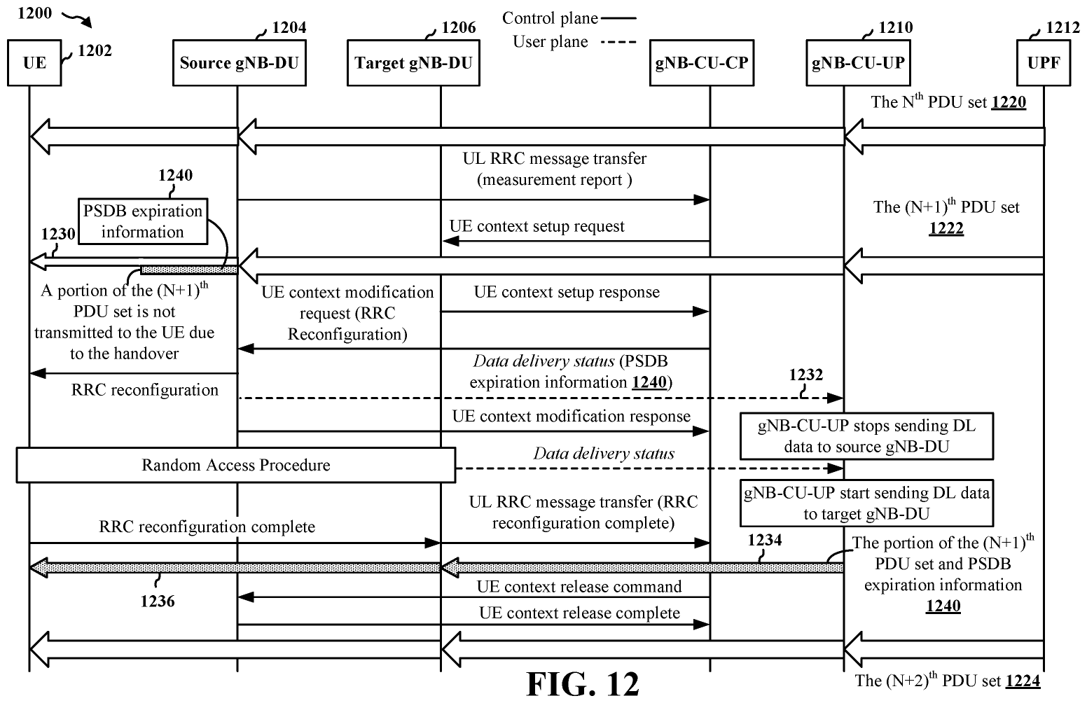

In some examples, for the source cell to transmit the transmission timing information, which may include one or more of the PSDB expiration information (e.g., the remaining time 916 or the 5G time 950 for the PSDB) or the synchronization threshold expiration information (e.g., the remaining time 1012 or the 5G time 1014 for the synchronization threshold 1010), to the target cell, the distributed unit (DU) of the source cell may provide the transmission timing information (e.g., the PSDB expiration information or the synchronization threshold expiration information) to the central unit-user plane (CU-UP) in a user plane message. For example, the user plane message may be the “Data Delivery Status” message. In some examples, the CU-UP may forwards the transmission timing information (e.g., the PSDB expiration information or the synchronization threshold expiration information) to the DU of the target cell through a general packet radio service (GPRS) tunneling protocol (GTP) user plane (GTP-U) header of the PDU set. FIG. 12 is a diagram 1200 illustrating an example of the transfer of the transmission timing information in accordance with various aspects of the present disclosure. In FIG. 12, the UPF 1212 transmits one or more PDU sets (e.g., PDU set 1220, 1222, 1224) to the UE 1202. The handover happens during the transmission of PDU set 1222. Hence, a portion of the PDU set 1222 may not be transmitted to the UE 1202 by the source cell (e.g., source gNB-DU 1204) at 1230. To facilitate the transmission of this portion of the PDU set 1222 by the target cell after the handover, the DU of the source cell (e.g., source gNB-DU 1204) may provide the transmission timing information (e.g., the PSDB expiration information 1240 for PDU set 1222) to the CU-UP (e.g., gNB-CU-UP 1210) at 1232 in a user plane message. For example, the user plane message may be the “Data Delivery Status” message. In some examples, the CU-UP (e.g., gNB-CU-UP 1210) may forwards the transmission timing information (e.g., the PSDB expiration information 1240) to the DU of the target cell (e.g., target gNB-DU 1206) at 1234 through a general packet radio service (GPRS) tunneling protocol (GTP) user plane (GTP-U) header of the PDU set 1222.

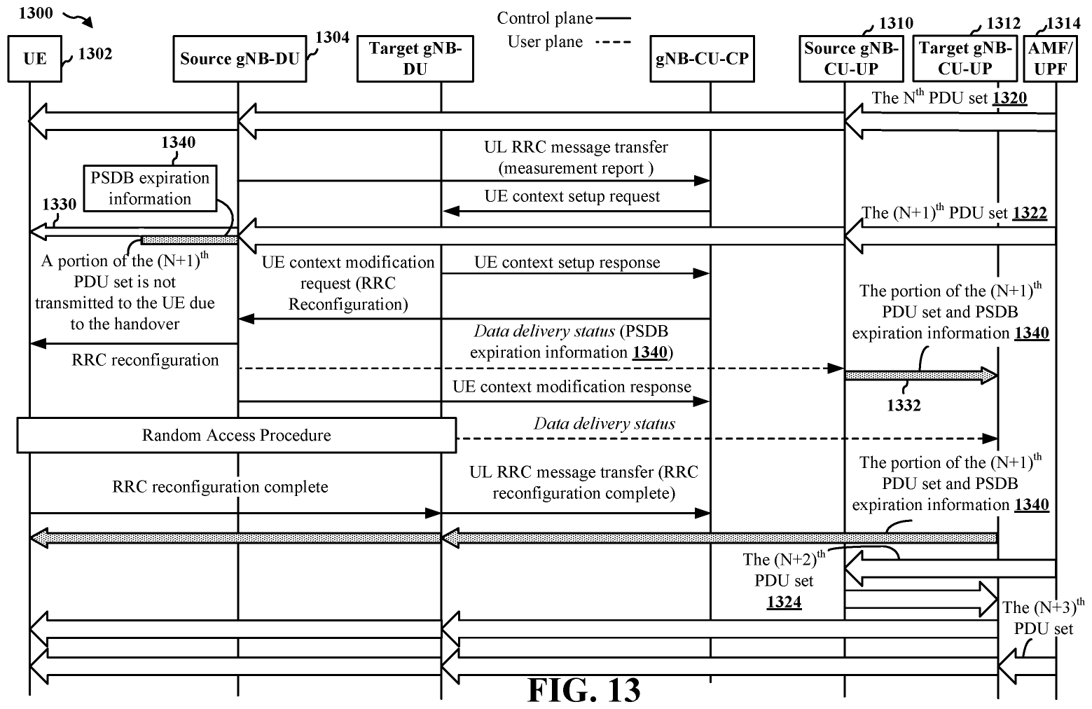

In some examples, for the source cell to transmit the transmission timing information (e.g., the PSDB expiration information or the synchronization threshold expiration information) to the target cell, the CU-UP of the source cell may provide the transmission timing information (e.g., the PSDB expiration information or the synchronization threshold expiration information) to the CU-UP of the target cell through the GTP-U header of the PDU set. FIG. 13 is a diagram 1300 illustrating an example of the transfer of the transmission timing information in accordance with various aspects of the present disclosure. In FIG. 13, the UPF 1314 transmits one or more PDU sets (e.g., PDU set 1320, 1322, 1324) to the UE 1302. The handover happens during the transmission of PDU set 1322. Hence, a portion of the PDU set 1322 may not be transmitted to the UE 1302 by the source cell (e.g., source gNB-DU 1304) at 1330. To facilitate the transmission of this portion of the PDU set 1322 by the target cell after the handover, the CU-UP of the source cell (e.g., source gNB-CU-UP 1310) may provide the transmission timing information (e.g., the PSDB expiration information 1340 of PDU set 1322) to the CU-UP of the target cell (e.g., target gNB-CU-UP 1312) at 1332 through the GTP-U header of the PDU set 1322.

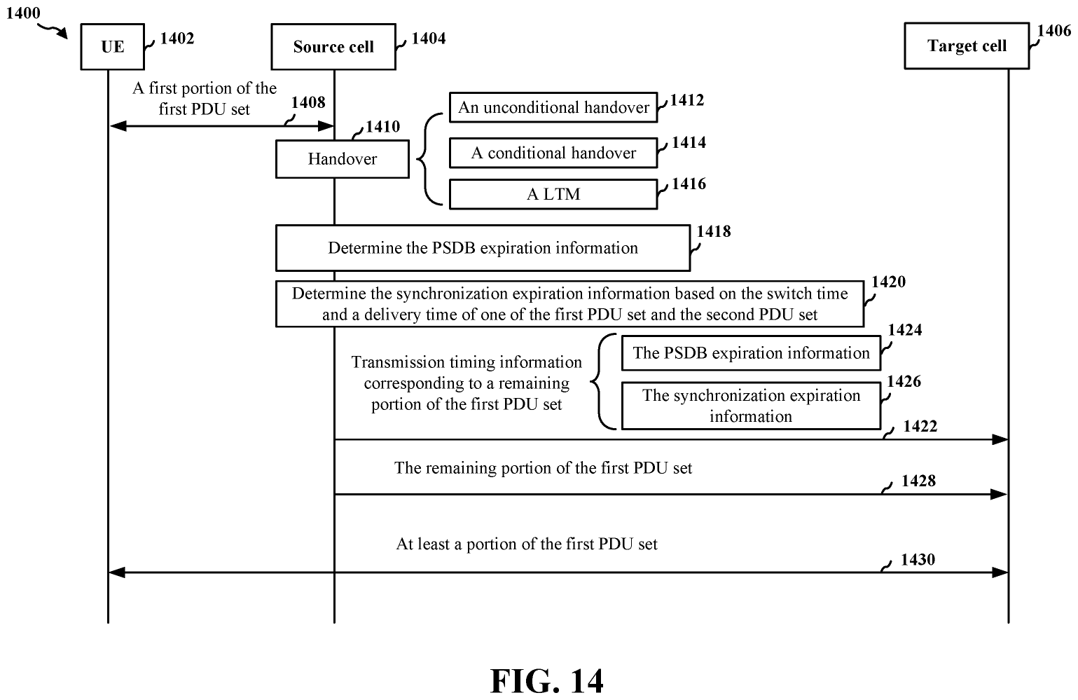

FIG. 14 is a call flow diagram 1400 illustrating a method of wireless communication in accordance with various aspects of this present disclosure. Various aspects are described in connection with a UE 1402, a source cell 1404, and a target cell 1406. The aspects may be performed by the UE 1402, the source cell 1404, or the target cell 1406. Each of the source cell 1404 and the target cell 1406 maybe a base station and/or one or more components of a base station (e.g., a CU 110, a DU 130, and/or an RU 140).

As shown in FIG. 14, at 1408, the UE 1402 may communicate (e.g., transmit or receive) a first portion of a PDU set with the source cell 1404. For example, referring to FIG. 9, the UE may receive a first portion (e.g., PDU 902, 904, 906) of a PDU set (e.g., PDU set 940) from the source cell.

At 1410, the source cell 1404 may perform a handover to the target cell 1406. For example, the handover may be one of an unconditional handover 1412, a conditional handover 1414, or a lower-layer triggered mobility (LTM) 1416, such as the layer 1/layer 2 (L1/L2) triggered mobility.

At 1418, the source cell 1404 may determine the PSDB expiration information for the first PDU set based on the switch time of the handover and the PSDB for the first PDU set. For example, referring to FIG. 9, the source cell may determine the PSDB expiration information (e.g., the remaining time 916 or the 5G time 950 for the PSDB of the PDU set 940) for the first PDU set (e.g., PDU set 940) based on the switch time of the handover (e.g., T₁) and the PSDB (e.g., AN-PSDB 946) for the first PDU set (e.g., PDU set 940).

At 1420, the source cell 1404 may determine the synchronization expiration information based on the switch time of the handover and the delivery time of one of the first PDU set and the second PDU set. For example, referring to FIG. 10A, the source cell may determine the synchronization expiration information between two PDU sets (e.g., PDU sets 1002 and 1004) based on the switch time of the handover (e.g., tₕ₁) and the delivery time (e.g., tₛ₁) of one of the first PDU set and the second PDU set (e.g., PDU set 1004).

At 1422, the source cell 1404 may provide the transmission timing information corresponding to the remaining portion of the first PDU set to the target cell 1406. In some examples, the transmission timing information may include one or more of: the PSDB expiration information 1424 of the first PDU set or the synchronization expiration information 1426 of the first PDU set. For example, referring to FIG. 12, the source cell (e.g., source gNB-DU 1204) may, via 1232 and 1234, provide the transmission timing information (e.g., PSDB expiration information 1240) corresponding to the remaining portion of the first PDU set (e.g., PDU set 1222) to the target cell (e.g., target gNB-DU 1206). Referring to FIG. 9, the transmission timing information may include the PSDB expiration information (e.g., the remaining time 916 or the 5G time 950) of the first PDU set (e.g., PDU set 940). Referring to FIG. 10A, the transmission timing information may include the synchronization expiration information (e.g., the remaining time 1012 or the 5G time 1014 for the synchronization threshold 1010).

At 1428, the source cell 1404 may provide (e.g., forward) the remaining portion of the first PDU set to the target cell 1406. For example, referring to FIG. 12, the source cell (e.g., source gNB-DU 1204) may provide, via 1232 and 1234, the remaining portion of the first PDU set to the target cell (e.g., target gNB-DU 1206).

At 1430, the target cell 1406 may communicate (e.g., transmit or receive) at least a portion of the first PDU set (e.g., the remaining portion of the first PDU set) based on the transmission timing information. For example, referring to FIG. 12, the target cell (e.g., target gNB-DU 1206) may transmit, at 1236, a portion of the first PDU set (e.g., PDU set 1222) based on the transmission timing information (e.g., the PSDB expiration information 1240).

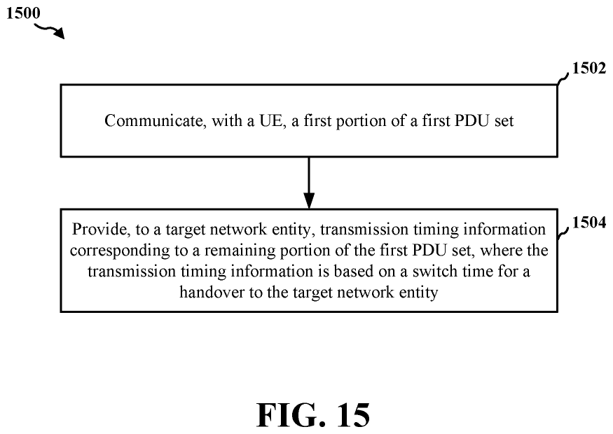

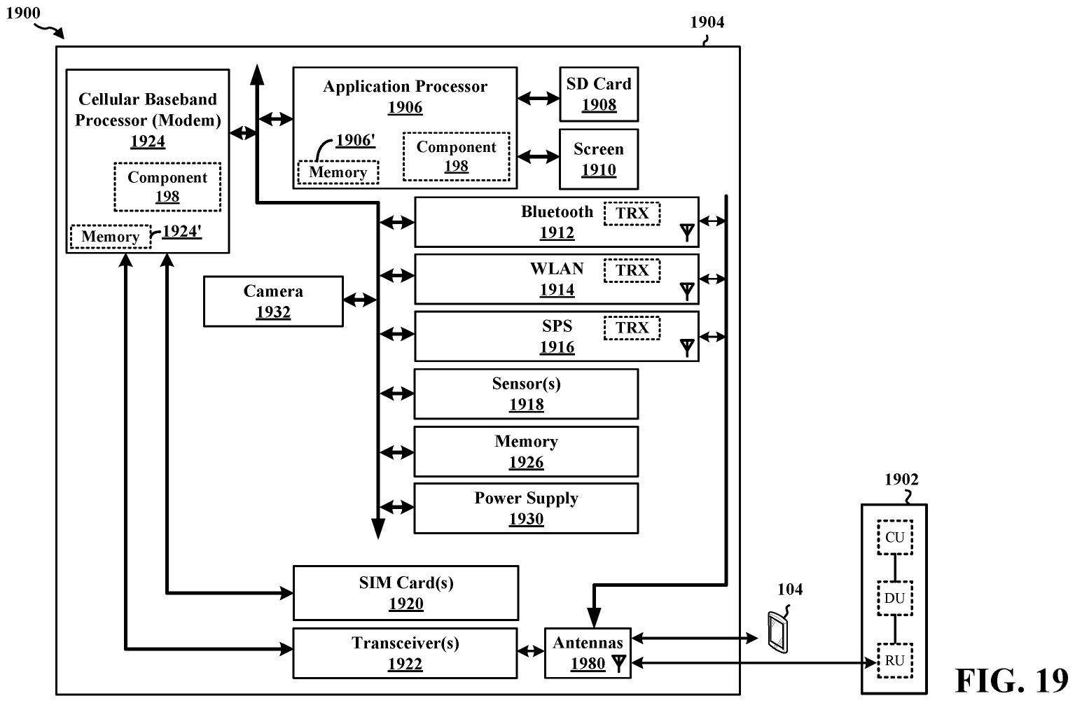

FIG. 15 is a flowchart 1500 illustrating methods of wireless communication at a source network entity in accordance with various aspects of the present disclosure. The method may be performed by the source network entity. The source network entity may be a base station, or a component of a base station, in the access network of FIG. 1 or a core network component (e.g., base station 102, 310; source cell 1404; source gNB-DU 1204; or the network entity 1902 in the hardware implementation of FIG. 19). The methods ensure that PDU sets are transmitted within their PSDB and synchronization thresholds during mobility procedures, such as handovers, thereby maintaining consistent service quality for latency-sensitive applications, such as XR applications. Additionally, by informing the target network entity of the PSDB expiration information and synchronization threshold expiration information for forwarded PDU sets, the methods enable more informed scheduling decisions, thereby improving resource utilization and reducing unnecessary delays.

As shown in FIG. 15, at 1502, the source network entity may communicate, with a UE, a first portion of a first PDU set. The UE may be the UE 104, 350, 1202, 1302, 1402, or the apparatus 1904 in the hardware implementation of FIG. 19. FIG. 9, FIG. 10A, FIG. 10B, FIG. 12, FIG. 13, and FIG. 14 illustrate various aspects of the steps in connection with flowchart 1500. For example, referring to FIG. 14, the source network entity (e.g., source cell 1404) may communicate, with a UE 1402, a first portion of a first PDU set. Referring to FIG. 9, the UE may receive a first portion (e.g., PDU 902, 904, 906) of a PDU set (e.g., PDU set 940) from the source cell. In some examples, 1502 may be performed by the mobility management component 199.

At 1504, the source network entity may provide, for a target network entity, transmission timing information corresponding to a remaining portion of the first PDU set. The transmission timing information is based on a switch time for a handover to the target network entity. The target network entity may be a base station, or a component of a base station, in the access network of FIG. 1 or a core network component (e.g., base station 102, 310; target cell 1406; target gNB-DU 1206; or the network entity 1902 in the hardware implementation of FIG. 19). For example, referring to FIG. 14, the source network entity (e.g., source cell 1404) may provide, at 1422, for a target network entity (e.g., target cell 1406), transmission timing information corresponding to a remaining portion of the first PDU set. Referring to FIG. 12, the source cell (e.g., source gNB-DU 1204) may, via 1232 and 1234, provide the transmission timing information (e.g., PSDB expiration information 1240) corresponding to the remaining portion of the first PDU set (e.g., PDU set 1222) to the target cell (e.g., target gNB-DU 1206). Referring to FIG. 9, the transmission timing information may include the PSDB expiration information (e.g., the remaining time 916 or the 5G time 950) of the first PDU set (e.g., PDU set 940). The transmission timing information (e.g., the remaining time 916 or the 5G time 950) may be based on the switch time (e.g., T₁) for a handover (e.g., handover 938) to the target network entity. In some examples, 1504 may be performed by the mobility management component 199.

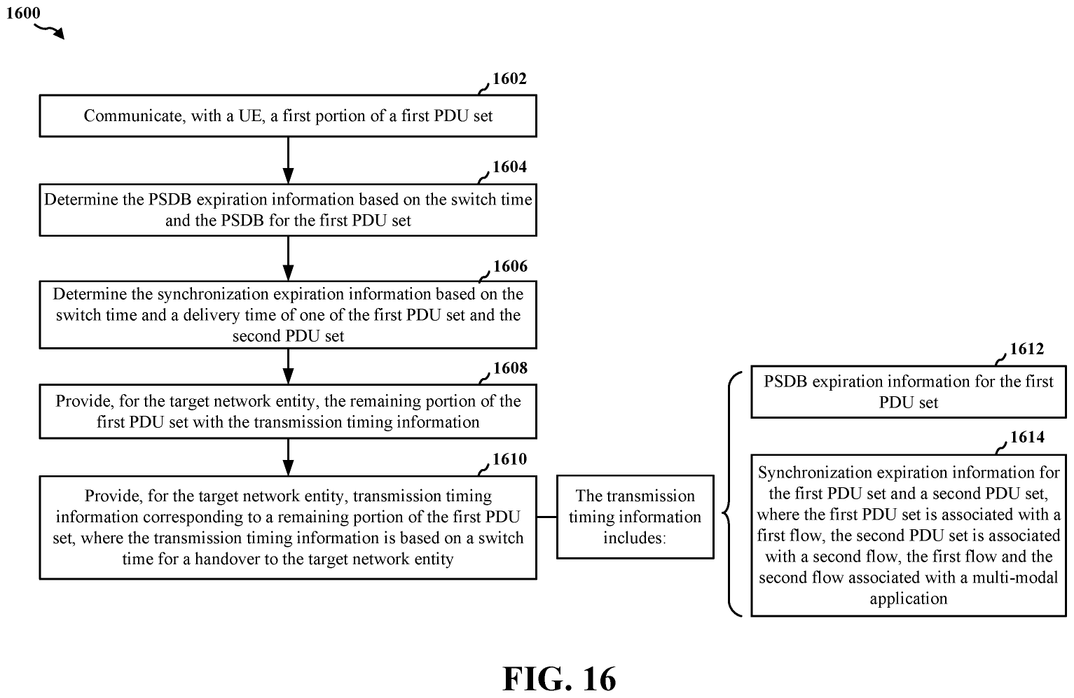

FIG. 16 is a flowchart 1600 illustrating methods of wireless communication at a source network entity in accordance with various aspects of the present disclosure. The method may be performed by the source network entity. The source network entity may be a base station, or a component of a base station, in the access network of FIG. 1 or a core network component (e.g., base station 102, 310; source cell 1404; source gNB-DU 1204; or the network entity 1902 in the hardware implementation of FIG. 19). The methods ensure that PDU sets are transmitted within their PSDB and synchronization thresholds during mobility procedures, such as handovers, thereby maintaining consistent service quality for latency-sensitive applications, such as XR applications. Additionally, by informing the target network entity of the PSDB expiration information and synchronization threshold expiration information for forwarded PDU sets, the methods enable more informed scheduling decisions, thereby improving resource utilization and reducing unnecessary delays.

As shown in FIG. 16, at 1602, the source network entity may communicate, with a UE, a first portion of a first PDU set. The UE may be the UE 104, 350, 1202, 1302, 1402, or the apparatus 1904 in the hardware implementation of FIG. 19. FIG. 9, FIG. 10A, FIG. 10B, FIG. 12, FIG. 13, and FIG. 14 illustrate various aspects of the steps in connection with flowchart 1600. For example, referring to FIG. 14, the source network entity (e.g., source cell 1404) may communicate, with a UE 1402, a first portion of a first PDU set. Referring to FIG. 9, the UE may receive a first portion (e.g., PDU 902, 904, 906) of a PDU set (e.g., PDU set 940) from the source cell. In some examples, 1602 may be performed by the mobility management component 199.

At 1610, the source network entity may provide, for a target network entity, transmission timing information corresponding to a remaining portion of the first PDU set. The transmission timing information is based on a switch time for a handover to the target network entity. The target network entity may be a base station, or a component of a base station, in the access network of FIG. 1 or a core network component (e.g., base station 102, 310; target cell 1406; target gNB-DU 1206; or the network entity 1902 in the hardware implementation of FIG. 19). For example, referring to FIG. 14, the source network entity (e.g., source cell 1404) may provide, at 1422, for a target network entity (e.g., target cell 1406), transmission timing information corresponding to a remaining portion of the first PDU set. Referring to FIG. 12, the source cell (e.g., source gNB-DU 1204) may, via 1232 and 1234, provide the transmission timing information (e.g., PSDB expiration information 1240) corresponding to the remaining portion of the first PDU set (e.g., PDU set 1222) to the target cell (e.g., target gNB-DU 1206). Referring to FIG. 9, the transmission timing information may include the PSDB expiration information (e.g., the remaining time 916 or the 5G time 950) of the first PDU set (e.g., PDU set 940). The transmission timing information (e.g., the remaining time 916 or the 5G time 950) may be based on the switch time (e.g., T₁) for a handover (e.g., handover 938) to the target network entity. In some examples, 1610 may be performed by the mobility management component 199.

In some aspects, the handover to the target network entity may include one or more of: an unconditional handover to the target network entity, a conditional handover to the target network entity, or a lower-layer triggered mobility (LTM) for the target network entity. For example, referring to FIG. 14, the handover to the target network entity (e.g., target cell 1406) may include one or more of: an unconditional handover 1412 to the target network entity (e.g., target cell 1406), a conditional handover 1414 to the target network entity (e.g., target cell 1406), or an LTM 1416 for the target network entity (e.g., target cell 1406).

In some aspects, the transmission timing information for the first PDU set may include one or more of: PSDB expiration information for the first PDU set (at 1612), or synchronization expiration information for the first PDU set and a second PDU set (at 1614). The first PDU set may be associated with a first flow, the second PDU set may be associated with a second flow, and the first flow and the second flow may be associated with a multi-modal application. For example, referring to FIG. 14, the transmission timing information for the first PDU set may include one or more of: PSDB expiration information for the first PDU set (at 1424), or synchronization expiration information for the first PDU set and a second PDU set (at 1426).

In some aspects, the transmission timing information for the first PDU set may include the PSDB expiration information for the first PDU set (at 1612). The PSDB expiration information may include one or more of: the remaining time until an expiration of a PSDB for the first PDU set, or the absolute time at the expiration of the PSDB for the first PDU set. For example, referring to FIG. _b4_, the PSDB expiration information may include one or more of: the remaining time 916 until an expiration of a PSDB for the first PDU set (e.g., PDU set 940), or the absolute time (e.g., 5G time 950) at the expiration of the PSDB for the first PDU set (e.g., PDU set 940).

In some aspects, at 1604, the UE may determine the PSDB expiration information based on the switch time and the PSDB for the first PDU set. For example, referring to FIG. 14, the UE 1402 may, at 1418, determine the PSDB expiration information. Referring to FIG. 9, the source cell may determine the PSDB expiration information (e.g., the remaining time 916 or the 5G time 950 for the PSDB of the PDU set 940) for the first PDU set (e.g., PDU set 940) based on the switch time of the handover (e.g., T₁) and the PSDB (e.g., AN-PSDB 946) for the first PDU set (e.g., PDU set 940). Referring to Equation (1), the PSDB expiration information (e.g., the remaining time RT_{PSDB}) may be based on the switch time (T₁) and the PSDB for the first PDU set (e.g., AN-PSDB). In some examples, 1604 may be performed by the mobility management component 199.

In some aspects, the absolute time at the expiration of the PSDB for the first PDU set may include the radio frame number at the expiration of the PSDB and the slot number inside the radio frame at the expiration of the PSDB. For example, referring to FIG. 9, the absolute time (e.g., 5G time 950) at the expiration of the PSDB for the first PDU set (e.g., PDU set 940) may include the radio frame number at the expiration of the PSDB and the slot number inside the radio frame at the expiration of the PSDB.

In some aspects, the PSDB expiration information may include a first designated value indicating the expiration of the PSDB. For example, referring to FIG. 14, the PSDB expiration information 1424 may include a first designated value indicating the expiration of the PSDB.

In some aspects, the transmission timing information for the first PDU set may include the synchronization expiration information for the first PDU set and the second PDU set (at 1614). The synchronization expiration information may include one or more of: the remaining time until an expiration of a synchronization threshold between the first PDU set and the second PDU set, or the absolute time at the expiration of the synchronization threshold. For example, referring to FIG. 10A, the synchronization expiration information may include one or more of: the remaining time 1012 until an expiration of a synchronization threshold 1010 between the first PDU set (e.g., PDU set 1002) and the second PDU set (e.g., PDU set 1004), or the absolute time (e.g., 5G time 1014) at the expiration of the synchronization threshold (e.g., synchronization threshold 1010).

In some aspects, at 1606, the source network entity may determine the synchronization expiration information based on the switch time and a delivery time of one of the first PDU set and the second PDU set. For example, referring to FIG. 14, the source network entity (e.g., source cell 1404) may, at 1420, determine the synchronization expiration information. Referring to Equation (2), the synchronization expiration information (the remaining time RT_{ST}) may be based on the switch time (T₁) and a delivery time (T₀) of one of the first PDU set and the second PDU set. Referring to FIG. 10A, the synchronization expiration information (the remaining time 1012) may be based on the switch time (tₕ₁) and a delivery time (tₛ₁) of one of the first PDU set and the second PDU set (e.g., PDU set 1004). In some examples, 1606 may be performed by the mobility management component 199.

In some aspects, the absolute time at the expiration of the synchronization threshold may include: the radio frame number at the expiration of the synchronization threshold and the slot number inside the radio frame at the expiration of the synchronization threshold. For example, referring to FIG. 10A, the absolute time (e.g., 5G time 1014) at the expiration of the synchronization threshold 1010 may include the radio frame number at the expiration of the synchronization threshold 1010 and the slot number inside the radio frame at the expiration of the synchronization threshold 1010.

In some aspects, at 1608, the source network entity may provide, for the target network entity, the remaining portion of the first PDU set with the transmission timing information. For example, referring to FIG. 14, the source network entity (e.g., source cell 1404) may provide, at 1428, for the target network entity (e.g., target cell 1406), the remaining portion of the first PDU set with the transmission timing information. In some examples, 1608 may be performed by the mobility management component 199.

In some aspects, to provide the transmission timing information (at 1610), the source network entity may provide, by a distributed unit (DU) of the source target entity, the transmission timing information to a central unit-user plane (CU-UP); and provide, by the CU-UP, the transmission timing information to the DU of the target network entity. For example, referring to FIG. 12, the DU of the source target entity (e.g., source gNB-DU 1204) may provide, at 1232, the transmission timing information (e.g., the PSDB expiration information 1240) to a CU-UP (e.g., gNB-CU-UP 1210). The CU-UP (e.g., gNB-CU-UP 1210) may further provide, at 1234, the transmission timing information (e.g., PSDB expiration information 1240) to the DU of the target network entity (e.g., target gNB-DU 1206).

In some aspects, to provide the transmission timing information to the CU-UP, the source network entity may provide the transmission timing information to the CU-UP via a UP message. To transmit the transmission timing information to the DU of the target network entity, the source network entity may provide the transmission timing information to the DU of the target network entity through a general packet radio service (GPRS) tunneling protocol (GTP) user plane (GTP-U) header of the first PDU set. For example, referring to FIG. 12, the source network entity (e.g., source gNB-DU 1204) may provide, at 1232, the transmission timing information (e.g., PSDB expiration information 1240) to the CU-UP (e.g., gNB-CU-UP 1210) via a UP message (e.g., the “Data Delivery Status” message). To transmit the transmission timing information to the DU of the target network entity (e.g., target gNB-DU 1206), the source network entity may provide the transmission timing information (e.g., PSDB expiration information 1240) to the DU of the target network entity (e.g., target gNB-DU 1206) through the GTP-U header of the first PDU set (e.g., PDU set 1222).

In some aspects, to provide the transmission timing information (at 1610), the source network entity may provide, by a CU-UP of the source network entity, the transmission timing information to the CU-UP of the target network entity through a GTP-U header of the first PDU set. For example, referring to FIG. 13, the CU-UP of the source network entity (e.g., source gNB-CU-UP 1310) may provide, at 1332, the transmission timing information (e.g., PSDB expiration information 1340) to the CU-UP of the target network entity (e.g., target gNB-CU-UP 1312) through a GTP-U header of the first PDU set.

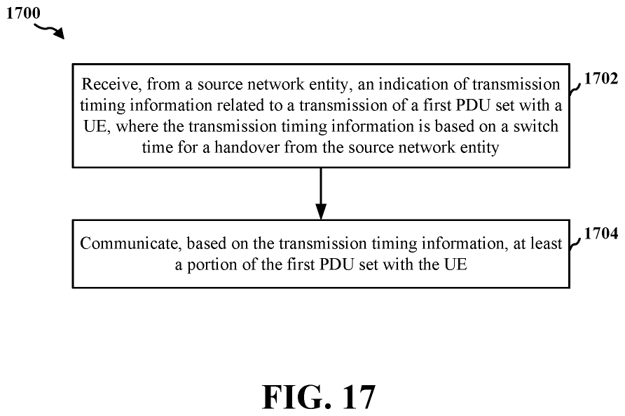

FIG. 17 is a flowchart 1700 illustrating methods of wireless communication at a target network entity in accordance with various aspects of the present disclosure. The method may be performed by the target network entity. The target network entity may be a base station, or a component of a base station, in the access network of FIG. 1 or a core network component (e.g., base station 102, 310; target cell 1406; or the network entity 1902 in the hardware implementation of FIG. 19). The methods ensure that PDU sets are transmitted within their PSDB and synchronization thresholds during mobility procedures, such as handovers, thereby maintaining consistent service quality for latency-sensitive applications, such as XR applications. Additionally, by informing the target network entity of the PSDB expiration information and synchronization threshold expiration information for forwarded PDU sets, the methods enable more informed scheduling decisions, thereby improving resource utilization and reducing unnecessary delays.

As shown in FIG. 17, at 1702, the target network entity may receive, from a source network entity, an indication of transmission timing information related to a transmission of a first PDU set with a UE. The transmission timing information may be based on a switch time for a handover from the source network entity. The UE may be the UE 104, 350, 1202, 1302, 1402, or the apparatus 1904 in the hardware implementation of FIG. 19. The source network entity may be a base station, or a component of a base station, in the access network of FIG. 1 or a core network component (e.g., base station 102, 310; source cell 1404; or the network entity 1902 in the hardware implementation of FIG. 19). FIG. 9, FIG. 10A, FIG. 10B, FIG. 12, FIG. 13, and FIG. 14 illustrate various aspects of the steps in connection with flowchart 1700. For example, referring to FIG. 14, the target network entity (e.g., target cell 1406) may receive, at 1422, from a source network entity (e.g., source cell 1404), an indication of transmission timing information related to a transmission of a first PDU set with a UE 1402. Referring to FIG. 9, the transmission timing information (e.g., the remaining time 916 for the PSDB) may be based on a switch time (e.g., T₁) for a handover (e.g., handover 938) from the source network entity. In some examples, 1702 may be performed by the mobility management component 199.

At 1704, the target network entity may communicate, based on the transmission timing information, at least a portion of the first PDU set with the UE. For example, referring to FIG. 14, the target network entity (e.g., target cell 1406) may communicate, at 1430, based on the transmission timing information (at 1422), at least a portion of the first PDU set with the UE 1402. In some aspects, _BS1_04 may be performed by the mobility management component 199.

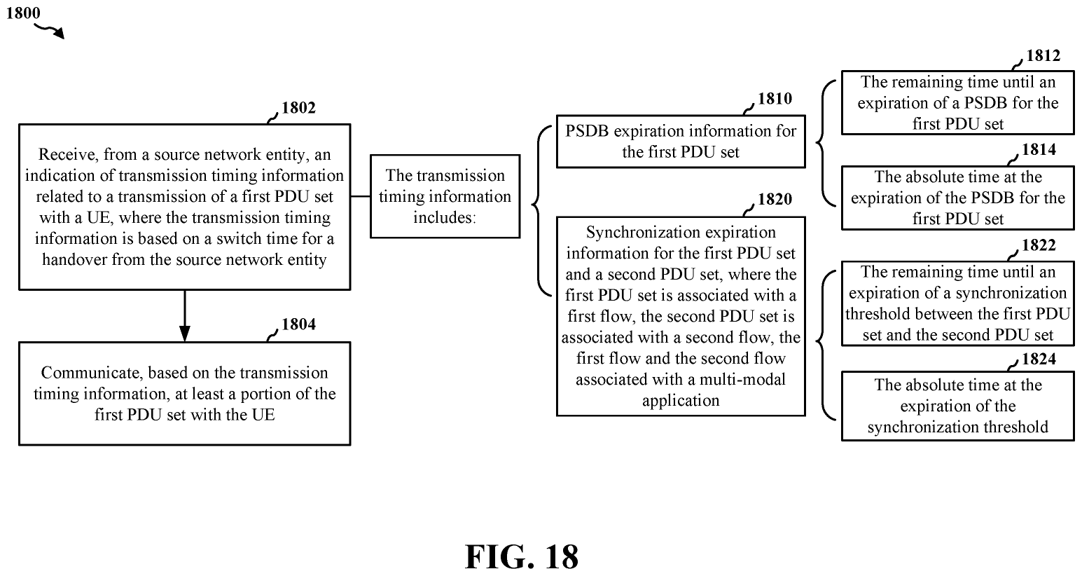

FIG. 18 is a flowchart 1800 illustrating methods of wireless communication at a target network entity in accordance with various aspects of the present disclosure. The method may be performed by the target network entity. The target network entity may be a base station, or a component of a base station, in the access network of FIG. 1 or a core network component (e.g., base station 102, 310; target cell 1406; or the network entity 1902 in the hardware implementation of FIG. 19). The methods ensure that PDU sets are transmitted within their PSDB and synchronization thresholds during mobility procedures, such as handovers, thereby maintaining consistent service quality for latency-sensitive applications, such as XR applications. Additionally, by informing the target network entity of the PSDB expiration information and synchronization threshold expiration information for forwarded PDU sets, the methods enable more informed scheduling decisions, thereby improving resource utilization and reducing unnecessary delays.

As shown in FIG. 18, at 1802, the target network entity may receive, from a source network entity, an indication of transmission timing information related to a transmission of a first PDU set with a UE. The transmission timing information may be based on a switch time for a handover from the source network entity. The UE may be the UE 104, 350, 1202, 1302, 1402, or the apparatus 1904 in the hardware implementation of FIG. 19. The source network entity may be a base station, or a component of a base station, in the access network of FIG. 1 or a core network component (e.g., base station 102, 310; source cell 1404; or the network entity 1902 in the hardware implementation of FIG. 19). FIG. 9, FIG. 10A, FIG. 10B, FIG. 12, FIG. 13, and FIG. 14 illustrate various aspects of the steps in connection with flowchart 1800. For example, referring to FIG. 14, the target network entity (e.g., target cell 1406) may receive, at 1422, from a source network entity (e.g., source cell 1404), an indication of transmission timing information related to a transmission of a first PDU set with a UE 1402. Referring to FIG. 9, the transmission timing information (e.g., the remaining time 916 for the PSDB) may be based on a switch time (e.g., T₁) for a handover (e.g., handover 938) from the source network entity. In some examples, 1802 may be performed by the mobility management component 199.

At 1804, the target network entity may communicate, based on the transmission timing information, at least a portion of the first PDU set with the UE. For example, referring to FIG. 14, the target network entity (e.g., target cell 1406) may communicate, at 1430, based on the transmission timing information (at 1422), at least a portion of the first PDU set with the UE 1402. In some aspects, 1804 may be performed by the mobility management component 199.

In some aspects, the handover from the source network entity may include one or more of: an unconditional handover from the source network entity, a conditional handover from the source network entity, or an LTM from the source network entity. For example, referring to FIG. 14, the handover from the source network entity (source cell 1404) may include one or more of: an unconditional handover 1412 from the source network entity (source cell 1404), a conditional handover 1414 from the source network entity (source cell 1404), or an LTM 1416 from the source network entity (source cell 1404).

In some aspects, the transmission timing information for the first PDU set (at 1802) may include one or more of: PSDB expiration information for the first PDU set (at 1810), or synchronization expiration information for the first PDU set and a second PDU set (at 1820). The first PDU set may be associated with a first flow, the second PDU set may be associated with a second flow, and the first flow and the second flow may be associated with a multi-modal application. For example, referring to FIG. 14, the transmission timing information for the first PDU set (at 1422) may include one or more of: PSDB expiration information 1424 for the first PDU set or synchronization expiration information 1426 for the first PDU set and a second PDU set (at 1820). Referring to FIG. 10A, the first PDU set (e.g., PDU set 1002) may be associated with a first flow (e.g., a flow for video frame), the second PDU set (e.g., PDU set 1004) may be associated with a second flow (e.g., a flow for haptic packet), and the first flow and the second flow may be associated with a multi-modal application.

In some aspects, the transmission timing information for the first PDU set may include the PSDB expiration information for the first PDU set (at 1810), and the PSDB expiration information may include one or more of: the remaining time until an expiration of a PSDB for the first PDU set (at 1812), or the absolute time at the expiration of the PSDB for the first PDU set (at 1814). For example, referring to FIG. _b4_, the PSDB expiration information may include one or more of: the remaining time 916 until an expiration of a PSDB for the first PDU set (e.g., PDU set 940), or the absolute time (e.g., 5G time 950) at the expiration of the PSDB for the first PDU set (e.g., PDU set 940).

In some aspects, the transmission timing information for the first PDU set may include the synchronization expiration information for the first PDU set and the second PDU set (at 1820). The synchronization expiration information may include one or more of: the remaining time until an expiration of a synchronization threshold between the first PDU set and the second PDU set (at 1822), or the absolute time at the expiration of the synchronization threshold (at 1824). For example, referring to FIG. 10A, the synchronization expiration information may include one or more of: the remaining time 1012 until an expiration of a synchronization threshold 1010 between the first PDU set (e.g., PDU set 1002) and the second PDU set (e.g., PDU set 1004), or the absolute time (e.g., 5G time 1014) at the expiration of the synchronization threshold 1010.

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include at least one cellular baseband processor (or processing circuitry) 1924 (also referred to as a modem) coupled to one or more transceivers 1922 (e.g., cellular RF transceiver). The cellular baseband processor(s) (or processing circuitry) 1924 may include at least one on-chip memory (or memory circuitry) 1924′. In some aspects, the apparatus 1904 may further include one or more subscriber identity modules (SIM) cards 1920 and at least one application processor (or processing circuitry) 1906 coupled to a secure digital (SD) card 1908 and a screen 1910. The application processor(s) (or processing circuitry) 1906 may include on-chip memory (or memory circuitry) 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor(s) (or processing circuitry) 1924 communicates through the transceiver(s) 1922 via one or more antennas 1980 with the UE 104 and/or with an RU associated with a network entity 1902. The cellular baseband processor(s) (or processing circuitry) 1924 and the application processor(s) (or processing circuitry) 1906 may each include a computer-readable medium/memory (or memory circuitry) 1924′, 1906′, respectively. The additional memory modules 1926 may also be considered a computer-readable medium/memory (or memory circuitry). Each computer-readable medium/memory (or memory circuitry) 1924′, 1906′, 1926 may be non-transitory. The cellular baseband processor(s) (or processing circuitry) 1924 and the application processor(s) (or processing circuitry) 1906 are each responsible for general processing, including the execution of software stored on the computer-readable medium/memory (or memory circuitry). The software, when executed by the cellular baseband processor(s) (or processing circuitry) 1924/application processor(s) (or processing circuitry) 1906, causes the cellular baseband processor(s) (or processing circuitry) 1924/application processor(s) (or processing circuitry) 1906 to perform the various functions described supra. The cellular baseband processor(s) (or processing circuitry) 1924 and the application processor(s) (or processing circuitry) 1906 are configured to perform the various functions described supra based at least in part of the information stored in the memory (or memory circuitry). That is, the cellular baseband processor(s) (or processing circuitry) 1924 and the application processor(s) (or processing circuitry) 1906 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1924/application processor(s) (or processing circuitry) 1906 when executing software. The cellular baseband processor(s) (or processing circuitry) 1924/application processor(s) (or processing circuitry) 1906 may be a component of the UE 350 and may include the at least one memory 360 and/or at least one of the TX processor 368, the RX processor 356, and the controller/processor 359. In one configuration, the apparatus 1904 may be at least one processor chip (modem and/or application) and include just the cellular baseband processor(s) (or processing circuitry) 1924 and/or the application processor(s) (or processing circuitry) 1906, and in another configuration, the apparatus 1904 may be the entire UE (e.g., see UE 350 of FIG. 3) and include the additional modules of the apparatus 1904.

As discussed supra, the component 198 may configured to perform any of the aspects described in connection with the UE 1402 in FIG. 14. The component 198 may be within the cellular baseband processor(s) (or processing circuitry) 1924, the application processor(s) (or processing circuitry) 1906, or both the cellular baseband processor(s) (or processing circuitry) 1924 and the application processor(s) (or processing circuitry) 1906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1904 may include a variety of components configured for various functions. In one configuration, the apparatus 1904, and in particular the cellular baseband processor(s) (or processing circuitry) 1924 and/or the application processor(s) (or processing circuitry) 1906, includes means for performing any of the aspects performed by the UE 1402 in FIG. 14. The means may be the component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

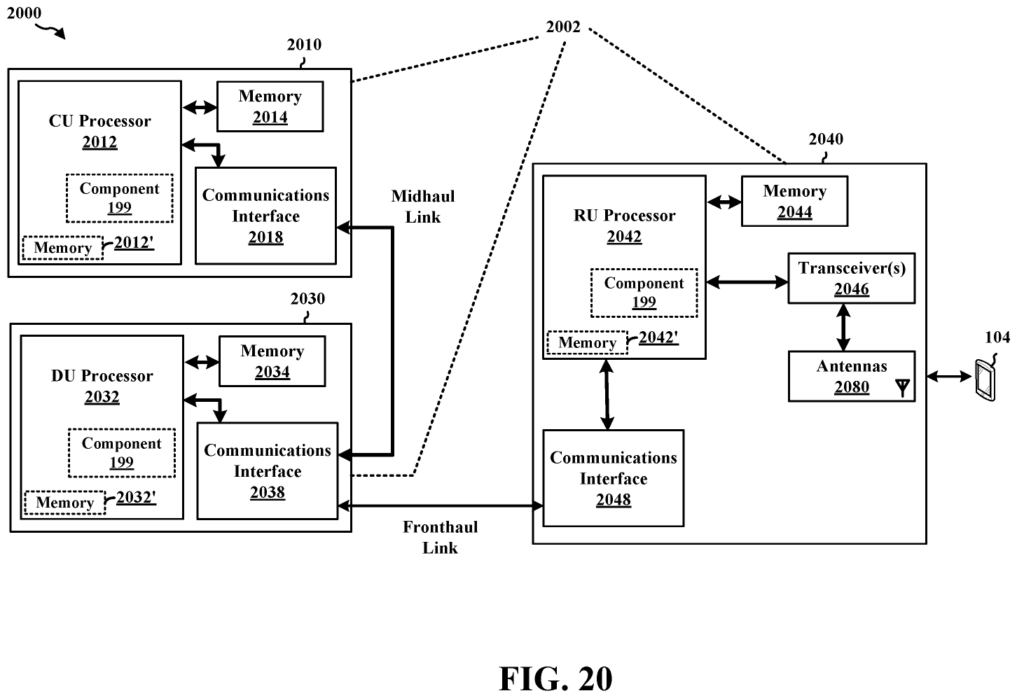

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include at least one CU processor (or processing circuitry) 2012. The CU processor(s) (or processing circuitry) 2012 may include on-chip memory (or memory circuitry) 2012′. In some aspects, the CU 2010 may further include additional memory modules 2014 and a communications interface 2018. The CU 2010 communicates with the DU 2030 through a midhaul link, such as an F1 interface. The DU 2030 may include at least one DU processor (or processing circuitry) 2032. The DU processor(s) (or processing circuitry) 2032 may include on-chip memory (or memory circuitry) 2032′. In some aspects, the DU 2030 may further include additional memory modules 2034 and a communications interface 2038. The DU 2030 communicates with the RU 2040 through a fronthaul link. The RU 2040 may include at least one RU processor (or processing circuitry) 2042. The RU processor(s) (or processing circuitry) 2042 may include on-chip memory (or memory circuitry) 2042′. In some aspects, the RU 2040 may further include additional memory modules 2044, one or more transceivers 2046, antennas 2080, and a communications interface 2048. The RU 2040 communicates with the UE 104. The on-chip memory (or memory circuitry) 2012′, 2032′, 2042′ and the additional memory modules 2014, 2034, 2044 may each be considered a computer-readable medium/memory (or memory circuitry). Each computer-readable medium/memory (or memory circuitry) may be non-transitory. Each of the processors (or processing circuitry) 2012, 2032, 2042 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to communicate, with a UE, a first portion of a first PDU set; and provide, for a target network entity, transmission timing information corresponding to a remaining portion of the first PDU set, where the transmission timing information is based on a switch time for a handover to the target network entity. The component 199 may be further configured to perform any of the aspects described in connection with the flowcharts in FIG. 17 and FIG. 18, and/or performed by the source cell 1404 in FIG. 14. The component 199 may be within one or more processors (or processing circuitry) of one or more of the CU 2010, DU 2030, and the RU 2040. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2002 may include a variety of components configured for various functions. In one configuration, the network entity 2002 includes means for communicating, with a UE, a first portion of a first PDU set, and means for providing, for a target network entity, transmission timing information corresponding to a remaining portion of the first PDU set, where the transmission timing information is based on a switch time for a handover to the target network entity. The network entity 2002 may further include means for performing any of the aspects described in connection with the flowcharts in FIG. 17 and FIG. 18, and/or aspects performed by the source cell 1404 in FIG. 14. The means may be the component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a source network entity. The method may include communicating, with a UE, a first portion of a first PDU set; and providing, to a target network entity, transmission timing information corresponding to a remaining portion of the first PDU set. The transmission timing information may be based on a switch time for a handover to the target network entity. The methods ensure that PDU sets are transmitted within their PSDB and synchronization thresholds during mobility procedures, such as handovers, thereby maintaining consistent service quality for latency-sensitive applications, such as XR applications. Additionally, by informing the target network entity of the PSDB expiration information and synchronization threshold expiration information for forwarded PDU sets, the methods enable more informed scheduling decisions, thereby improving resource utilization and reducing unnecessary delays.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a source network entity. The method includes communicating, with a user equipment (UE), a first portion of a first protocol data unit (PDU) set; and providing, to a target network entity, transmission timing information corresponding to a remaining portion of the first PDU set, wherein the transmission timing information is based on a switch time for a handover to the target network entity.

Aspect 2 is the method of aspect 1, wherein the handover to the target network entity includes one or more of: an unconditional handover to the target network entity, a conditional handover to the target network entity, or a lower-layer triggered mobility (LTM) for the target network entity.

Aspect 3 is the method of any of aspects 1 to 2, wherein the transmission timing information for the first PDU set comprises one or more of: PDU set delay budget (PSDB) expiration information for the first PDU set, or synchronization expiration information for the first PDU set and a second PDU set, wherein the first PDU set is associated with a first flow, the second PDU set is associated with a second flow, the first flow and the second flow associated with a multi-modal application.

Aspect 4 is the method of aspect 3, wherein the transmission timing information for the first PDU set comprises the PSDB expiration information for the first PDU set, and the PSDB expiration information comprises one or more of: a remaining time until an expiration of a PSDB for the first PDU set, or an absolute time at the expiration of the PSDB for the first PDU set.

Aspect 5 is the method of aspect 4, where the method further includes determining the PSDB expiration information based on the switch time and the PSDB for the first PDU set.

Aspect 6 is the method of aspect 4, wherein the absolute time at the expiration of the PSDB for the first PDU set comprises a radio frame number at the expiration of the PSDB and a slot number inside a radio frame at the expiration of the PSDB.

Aspect 7 is the method of aspect 4, wherein the PSDB expiration information includes a first designated value indicating the expiration of the PSDB.

Aspect 8 is the method of aspect 3, wherein the transmission timing information for the first PDU set comprises the synchronization expiration information for the first PDU set and the second PDU set, and wherein the synchronization expiration information comprises one or more of: a remaining time until an expiration of a synchronization threshold between the first PDU set and the second PDU set, or an absolute time at the expiration of the synchronization threshold.

Aspect 9 is the method of aspect 8, where the method further includes determining the synchronization expiration information based on the switch time and a delivery time of one of the first PDU set and the second PDU set.

Aspect 10 is the method of any of aspects 8 and 9, wherein the absolute time at the expiration of the synchronization threshold comprises a radio frame number at the expiration of the synchronization threshold and a slot number inside a radio frame at the expiration of the synchronization threshold.

Aspect 11 is the method of any of aspects 1 to 10, where the method further includes providing, for the target network entity, the remaining portion of the first PDU set with the transmission timing information.

Aspect 12 is the method of any of aspects 1 to 11, wherein providing the transmission timing information comprises: providing, by a distributed unit (DU) of the source target entity, the transmission timing information to a central unit-user plane (CU-UP) of the source network entity; and providing, by the CU-UP of the source network entity, the transmission timing information to the DU of the target network entity.

Aspect 13 is the method of aspect 12, wherein providing the transmission timing information to the CU-UP of the source network entity comprises: providing the transmission timing information to the CU-UP of the source network entity via a UP message, and wherein transmitting the transmission timing information to the DU of the target network entity comprises: providing the transmission timing information to the DU of the target network entity through a general packet radio service (GPRS) tunneling protocol (GTP) user plane (GTP-U) header of the first PDU set.

Aspect 14 is the method of any of aspects 1 to 11, wherein providing the transmission timing information comprises: providing, by a central unit-user plane (CU-UP) of the source network entity, the transmission timing information to the CU-UP of the target network entity through a general packet radio service (GPRS) tunneling protocol (GTP) user plane (GTP-U) header of the first PDU set.

Aspect 15 is an apparatus for wireless communication at a source network entity, comprising: a processing system that includes processor circuitry and memory circuitry that stores code and is coupled with the processor circuitry, the processing system configured to cause the source network entity to perform the method of one or more of aspects 1-14.

Aspect 16 is an apparatus for wireless communication at a source network entity, comprising: at least one memory; and at least one processor coupled to the at least one memory and, where the at least one processor, individually or in any combination, is configured to perform the method of any of aspects 1-14.

Aspect 17 is the apparatus for wireless communication at a source network entity, comprising means for performing each step in the method of any of aspects 1-14.

Aspect 18 is an apparatus of any of aspects 15-17, further comprising a transceiver configured to receive or to transmit in association with the method of any of aspects 1-14.

Aspect 19 is a computer-readable medium (e.g., a non-transitory computer-readable medium) storing computer executable code at a source network entity, the code when executed by at least one processor causes the at least one processor to, individually or in any combination, perform the method of any of aspects 1-14.

Aspect 20 is a method of wireless communication at a target network entity. The method includes receiving, from a source network entity, an indication of transmission timing information related to a transmission of a first protocol data unit (PDU) set with a user equipment (UE), wherein the transmission timing information is based on a switch time for a handover from the source network entity; and communicating, based on the transmission timing information, at least a portion of the first PDU set with the UE.

Aspect 21 is the method of aspect 20, wherein the handover from the source network entity includes one or more of: an unconditional handover from the source network entity, a conditional handover from the source network entity, or a lower-layer triggered mobility (LTM) from the source network entity.

Aspect 22 is the method of any of aspect 20 to 21, wherein the transmission timing information for the first PDU set comprises one or more of: PDU set delay budget (PSDB) expiration information for the first PDU set, or synchronization expiration information for the first PDU set and a second PDU set, wherein the first PDU set is associated with a first flow, the second PDU set is associated with a second flow, the first flow and the second flow associated with a multi-modal application.

Aspect 23 is the method of aspect 22, wherein the transmission timing information for the first PDU set comprises the PSDB expiration information for the first PDU set, and the PSDB expiration information comprises one or more of: a remaining time until an expiration of a PSDB for the first PDU set, or an absolute time at the expiration of the PSDB for the first PDU set.

Aspect 24 is the method of aspect 22, wherein the transmission timing information for the first PDU set comprises the synchronization expiration information for the first PDU set and the second PDU set, and wherein the synchronization expiration information comprises one or more of: a remaining time until an expiration of a synchronization threshold between the first PDU set and the second PDU set, or an absolute time at the expiration of the synchronization threshold.

Aspect 25 is an apparatus for wireless communication at a target network entity, comprising: a processing system that includes processor circuitry and memory circuitry that stores code and is coupled with the processor circuitry, the processing system configured to cause the network entity to perform the method of one or more of aspects 20-24.

Aspect 26 is an apparatus for wireless communication at a target network entity, comprising: at least one memory; and at least one processor coupled to the at least one memory and, where the at least one processor, individually or in any combination, is configured to perform the method of any of aspects 20-24.

Aspect 27 is the apparatus for wireless communication at a target network entity, comprising means for performing each step in the method of any of aspects 20-24.

Aspect 28 is an apparatus of any of aspects 25-27, further comprising a transceiver configured to receive or to transmit in association with the method of any of aspects 20-24.

Aspect 29 is a computer-readable medium (e.g., a non-transitory computer-readable medium) storing computer executable code at a target network entity, the code when executed by at least one processor causes the at least one processor to, individually or in any combination, perform the method of any of aspects 20-24.

What is claimed is:

1. An apparatus for wireless communication at a source network entity, comprising:
at least one memory; and
at least one processor coupled to the at least one memory and, based at least in part on information stored in the at least one memory, the at least one processor, individually or in any combination, is configured to cause the source network entity to:
communicate, with a user equipment (UE), a first portion of a first protocol data unit (PDU) set; and
provide, for a target network entity, transmission timing information corresponding to a remaining portion of the first PDU set, wherein the transmission timing information is based on a switch time for a handover to the target network entity.

2. The apparatus of claim 1, further comprising a transceiver coupled to the at least one processor, wherein to communicate the first portion of the first PDU set, the at least one processor, individually or in any combination, is configured to cause the source network entity to communicate the first portion of the first PDU set via the transceiver, and wherein the handover to the target network entity includes one or more of:
an unconditional handover to the target network entity,
a conditional handover to the target network entity, or
a lower-layer triggered mobility (LTM) for the target network entity.

3. The apparatus of claim 2, wherein the transmission timing information for the first PDU set comprises one or more of:
PDU set delay budget (PSDB) expiration information for the first PDU set, or
synchronization expiration information for the first PDU set and a second PDU set, wherein the first PDU set is associated with a first flow, the second PDU set is associated with a second flow, the first flow and the second flow associated with a multi-modal application.

4. The apparatus of claim 3, wherein the transmission timing information for the first PDU set comprises the PSDB expiration information for the first PDU set, and the PSDB expiration information comprises one or more of:
a remaining time until an expiration of a PSDB for the first PDU set, or
an absolute time at the expiration of the PSDB for the first PDU set.

5. The apparatus of claim 4, wherein the at least one processor, individually or in any combination, is further configured to cause the source network entity to:
determine the PSDB expiration information based on the switch time and the PSDB for the first PDU set.

6. The apparatus of claim 4, wherein the absolute time at the expiration of the PSDB for the first PDU set comprises:
a radio frame number at the expiration of the PSDB, and
a slot number inside a radio frame at the expiration of the PSDB.

7. The apparatus of claim 4, wherein the PSDB expiration information includes a first designated value indicating the expiration of the PSDB.

8. The apparatus of claim 3, wherein the transmission timing information for the first PDU set comprises the synchronization expiration information for the first PDU set and the second PDU set, and wherein the synchronization expiration information comprises one or more of:
a remaining time until an expiration of a synchronization threshold between the first PDU set and the second PDU set, or
an absolute time at the expiration of the synchronization threshold.

9. The apparatus of claim 8, wherein the at least one processor, individually or in any combination, is further configured to cause the source network entity to:
determine the synchronization expiration information based on the switch time and a delivery time of one of the first PDU set and the second PDU set.

10. The apparatus of claim 8, wherein the absolute time at the expiration of the synchronization threshold comprises:
a radio frame number at the expiration of the synchronization threshold, and
a slot number inside a radio frame at the expiration of the synchronization threshold.

11. The apparatus of claim 1, wherein the at least one processor, individually or in any combination, is configured to cause the source network entity to:
provide, for the target network entity, the remaining portion of the first PDU set with the transmission timing information.

12. The apparatus of claim 1, wherein to provide the transmission timing information, the at least one processor, individually or in any combination, is configured to cause the source network entity to:
provide, by a distributed unit (DU) of the source target entity, the transmission timing information to a central unit-user plane (CU-UP); and
provide, by the CU-UP, the transmission timing information to the DU of the target network entity.

13. The apparatus of claim 12, wherein to provide the transmission timing information to the CU-UP, the at least one processor, individually or in any combination, is configured to cause the source network entity to:
provide the transmission timing information to the CU-UP via a UP message, and wherein to provide the transmission timing information to the DU of the target network entity, the at least one processor, individually or in any combination, is configured to cause the source network entity to:
provide the transmission timing information to the DU of the target network entity through a general packet radio service (GPRS) tunneling protocol (GTP) user plane (GTP-U) header of the first PDU set.

14. The apparatus of claim 1, wherein to provide the transmission timing information, the at least one processor, individually or in any combination, is configured to cause the source network entity to:
provide, by a central unit-user plane (CU-UP) of the source network entity, the transmission timing information to the CU-UP of the target network entity through a general packet radio service (GPRS) tunneling protocol (GTP) user plane (GTP-U) header of the first PDU set.

15. An apparatus for wireless communication at a target network entity, comprising:
at least one memory; and
at least one processor coupled to the at least one memory and, based at least in part on information stored in the at least one memory, the at least one processor, individually or in any combination, is configured to cause the target network entity to:
receive, from a source network entity, an indication of transmission timing information related to a transmission of a first protocol data unit (PDU) set with a user equipment (UE), wherein the transmission timing information is based on a switch time for a handover from the source network entity; and
communicate, based on the transmission timing information, at least a portion of the first PDU set with the UE.

16. The apparatus of claim 15, further comprising a transceiver coupled to the at least one processor, wherein to receive the indication of the transmission timing information, the at least one processor, individually or in any combination, is configured to cause the target network entity to receive the indication of the transmission timing information via the transceiver, and wherein the handover from the source network entity includes one or more of:
an unconditional handover from the source network entity,
a conditional handover from the source network entity, or
a lower-layer triggered mobility (LTM) from the source network entity.

17. The apparatus of claim 16, wherein the transmission timing information for the first PDU set comprises one or more of:
PDU set delay budget (PSDB) expiration information for the first PDU set, or
synchronization expiration information for the first PDU set and a second PDU set, wherein the first PDU set is associated with a first flow, the second PDU set is associated with a second flow, the first flow and the second flow associated with a multi-modal application.

18. The apparatus of claim 17, wherein the transmission timing information for the first PDU set comprises the PSDB expiration information for the first PDU set, and the PSDB expiration information comprises one or more of:
a remaining time until an expiration of a PSDB for the first PDU set, or
an absolute time at the expiration of the PSDB for the first PDU set.

19. The apparatus of claim 17, wherein the transmission timing information for the first PDU set comprises the synchronization expiration information for the first PDU set and the second PDU set, and wherein the synchronization expiration information comprises one or more of:
a remaining time until an expiration of a synchronization threshold between the first PDU set and the second PDU set, or
an absolute time at the expiration of the synchronization threshold.

20. A method of wireless communication at a source network entity, comprising:
communicating, with a user equipment (UE), a first portion of a first protocol data unit (PDU) set; and
providing, to a target network entity, transmission timing information corresponding to a remaining portion of the first PDU set, wherein the transmission timing information is based on a switch time for a handover to the target network entity.
